(19) United States
(12) Patent Application Publication
(10) Pub. No.: US 2017/0076307 A1
(43) Pub. Date: Mar. 16, 2017

(54) PRICE ESTIMATION DEVICE, PRICE ESTIMATION METHOD, AND RECORDING MEDIUM

(71) Applicant: NEC Corporation, Minato-ku, Tokyo (JP)

(72) Inventors: Yosuke MOTOHASHI, Tokyo (JP); Satoshi MORINAGA, Tokyo (JP); Ryohei FUJIMAKI, Tokyo (JP); Riki ETO, Tokyo (JP); Masato ASAHARA, Tokyo (JP)

(73) Assignee: NEC Corporation, Minato-ku, Tokyo (JP)

(21) Appl. No.: 15/125,267

(22) PCT Filed: Feb. 27, 2015
(86) PCT No.: PCT/JP2015/001024

§ 371 Date: Sep. 12, 2016

Related U.S. Application Data
(60) Provisional application No. 61/971,594, filed on Mar. 28, 2014.

(51) Int. Cl. G06Q 30/02

(52) U.S. Cl. CPC G06Q 30/0206; G06Q 30/0202

(57) ABSTRACT

A price estimation device that can predict a price with a high degree of precision is disclosed. Said price estimation device has a price-predicting means that predicts a price pertaining to second information in a target second time period by applying rule information to said second information, which includes explanatory variables. Said rule information represents the relationship between the explanatory variables and the price, said relationship having been extracted on the basis of a first-information set comprising first information in which explanatory-variable values are associated with price values. The explanatory variables include an attribute that represents a length of time, determined on the basis of a first time period in which a specific event occurs, pertaining to a target object associated with the aforementioned first information or the abovementioned second information. The value of said attribute in the second information is the length of time between the first time period and the second time period, and the value of the attribute in the first information is the length of time between the first time period and a third time period associated with the abovementioned price.

### BACKGROUND ART

The present invention relates to a price estimation device, a price estimation method, and recording medium.

For example, a price related to a target object such as a used building, a used car, and a used device varies depending on durable years, presence or absence of a failure, frequency of maintenance, a degree of wear, and the like. Correlation between values of factors and a price is analyzed by analyzing statistical data where the values of factors potentially influencing a price of a target object, such as durable years, is associated with the price. Further, estimation of a price of a target object is performed on the basis of the analysis result.

PTL 1 discloses a remaining-value prediction system predicting a remaining value of a target object.

The remaining-value prediction system includes a used-article price database storing an elapsed time related to a target object, and a used-article circulating price (or a ratio of the used-article circulating price to a new-article price) related to the target object. The remaining-value prediction system obtains a function associating the elapsed time with the used-article circulating price, based on the used-article price database. Next, the remaining-value prediction system estimates a used-article circulating price related to a new target object by applying the function to an elapsed time related to the new target object.

NPL 1 disclose methods for determining the type of observation probability by approximating the complete marginal likelihood function for a mixture model that typifies the latent variable model and, then, maximizing its lower bound (lower limit) as an example of prediction techniques.

### CITATION LIST

### Patent Literature

[PTL 1] Japanese Unexamined Patent Application Publication No. 2002-140462

### Non-Patent Literature

[NPL 1] Ryohei Fujimaki, Satoshi Morinaga: Factorized Asymptotic Bayesian Inference for Mixture Modeling. Proceedings_of_the_fifteenth_international_conference_on_Artificial_Intelligence_and_Statistics (AISTATS), March 2012.

### SUMMARY OF INVENTION

### Technical Problem

The remaining-value prediction system disclosed in PTL 1 cannot always predict remaining-values accurately.

In order to solve the aforementioned problem, one of objects of the present invention is to provide a price estimation device, a price estimation method, a recording medium, and the like, being capable of predicting a price.

As an aspect of the present invention, a price estimation device including:

prediction data input means for inputting prediction data being one or more explanatory variables potentially influencing a price;

component determination means for determining a component used for prediction of the price on the basis of a hierarchical latent structure in which a latent variable is expressed by a hierarchical structure which includes one or more nodes arranged at each level of the hierarchical structure, a path between a node arranged at a first level and a node arranged at a subordinate second level, and the component representing a probability model is arranged in a node at a lowest level of the hierarchical structure,
a gating function model being a basis of determining the path between nodes constituting the hierarchical latent structure, when determining the component, and
the prediction data; and

price prediction means for predicting the price on the basis of the component determined by the component determination means and the prediction data.

In addition, as another aspect of the present invention, a price estimation method including:

inputting prediction data being one or more explanatory variables potentially influencing a price;

determining a component used for prediction of the price on the basis of a hierarchical latent structure in which a latent variable is expressed by a hierarchical structure which includes one or more nodes arranged at each level of the hierarchical structure, a path between a node arranged at a first level and a node arranged at a subordinate second level, and the component representing a probability model is arranged in a node at a lowest level of the hierarchical structure,
a gating function model being a basis of determining the path between nodes constituting the hierarchical latent structure, when determining the component, and
the prediction data; and

predicting the price on the basis of the component determined by the component determination means and the prediction data

Furthermore, the object is also realized by a price estimation program, and a computer-readable recording medium which records the program.

### Advantageous Effects of Invention

According to the above-mentioned aspects, a price with a high degree of precision can be predicted.

### BRIEF DESCRIPTION OF DRAWINGS

FIG. 1 is a block diagram illustrating an exemplary configuration of a price estimation system according to at least one exemplary embodiment of the present invention.

FIG. 2A is a table illustrating an example of information stored in a learning database according to at least one exemplary embodiment of the present invention.

FIG. 2B is a table illustrating an example of information stored in a learning database according to at least one exemplary embodiment of the present invention.

FIG. 2C is a table illustrating an example of information stored in a learning database according to at least one exemplary embodiment of the present invention.

FIG. 2D is a table illustrating an example of information stored in a learning database according to at least one exemplary embodiment of the present invention.

FIG. 3 is a block diagram illustrating an exemplary configuration of a hierarchical latent variable model estimation device according to at least one exemplary embodiment of the present invention.

FIG. 4 is a block diagram illustrating an exemplary configuration of a hierarchical latent variable variational probability computation unit according to at least one exemplary embodiment of the present invention.

FIG. 5 is a block diagram illustrating an exemplary configuration of a gating function model optimization unit according to at least one exemplary embodiment of the present invention.

FIG. 6 is a flowchart illustrating an exemplary operation of the hierarchical latent variable model estimation device according to at least one exemplary embodiment of the present invention.

FIG. 7 is a flowchart illustrating an exemplary operation of the hierarchical latent variable variational probability computation unit according to at least one exemplary embodiment of the present invention.

FIG. 8 is a flowchart illustrating an exemplary operation of the gating function model optimization unit according to at least one exemplary embodiment of the present invention.

FIG. 9 is a block diagram illustrating an exemplary configuration of a price estimation device according to at least one exemplary embodiment of the present invention.

FIG. 10 is a flowchart illustrating an exemplary operation of a price estimation device according to at least one exemplary embodiment of the present invention.

FIG. 11 is a block diagram illustrating an exemplary configuration of another hierarchical latent variable model estimation device according to at least one exemplary embodiment of the present invention.

FIG. 12 is a block diagram illustrating an exemplary configuration of a hierarchical latent structure optimization unit according to at least one exemplary embodiment.

FIG. 13 is a flowchart illustrating an exemplary operation of the hierarchical latent variable model estimation device according to at least one exemplary embodiment of the present invention.

FIG. 14 is a flowchart illustrating an exemplary operation of the hierarchical latent structure optimization unit according to at least one exemplary embodiment of the present invention.

FIG. 15 is a block diagram illustrating an exemplary configuration of another gating function model optimization unit according to at least one exemplary embodiment of the present invention.

FIG. 16 is a flowchart illustrating an exemplary operation of the gating function model optimization unit according to at least one exemplary embodiment of the present invention.

FIG. 17 is a block diagram illustrating a basic configuration of another hierarchical latent variable model estimation device according to at least one exemplary embodiment of the present invention.

FIG. 18 is a block diagram illustrating a basic configuration of a price estimation device according to at least one exemplary embodiment of the present invention.

FIG. 19 is a schematic block diagram illustrating a configuration of a computer according to at least one exemplary embodiment of the present invention.

FIG. 20 is a block diagram illustrating a configuration of an estimation device according to a fourth exemplary embodiment of the present invention.

FIG. 21 is a diagram conceptually illustrating an example of a first information set according to at least one of the exemplary embodiments of the present invention.

FIG. 22 is a block diagram illustrating a configuration of a price estimation device according to a fifth exemplary embodiment of the present invention.

FIG. 23 is a diagram illustrating an example of a gating function model and a component.

FIG. 24 is a block diagram illustrating a configuration of a price estimation device according to a sixth exemplary embodiment of the present invention.

FIG. 25 is a flowchart illustrating a processing flow in a price estimation device according to a sixth exemplary embodiment.

FIG. 26 is a block diagram illustrating a configuration of a price estimation device according to a seventh exemplary embodiment of the present invention.

FIG. 27 is a flowchart illustrating a processing flow in a price estimation device according to a seventh exemplary embodiment.

### DESCRIPTION OF EMBODIMENTS

(Applicant's note: Greek alphabet ‘phi’ may appear differently between in the following text and in the following Eqns. due to a constraint of font of a writing software such as Microsoft Word. Even when Geek alphabet ‘phi’ appears differently, the difference in appearance does not mean anything.) In order to facilitate understanding of the invention, problems to be solved by the present invention will be first described in detail.

There is a problem that, even when the method described in NPL 1 is applied to price prediction, a model selection problem in a model including hierarchical latent variables cannot be solved.

The reason is that the method described in NPL 1 does not take hierarchical latent variables into consideration and, therefore, a computation procedure cannot be self-evidently constructed. Further, the method described in NPL 1 is based on a strong assumption that the method cannot be applied in the presence of hierarchical latent variables, and therefore theoretical justification is lost when the method is simply applied to price prediction.

Further, there is a problem that the remaining-value prediction system disclosed in PTL 1 does not necessarily provide a high degree of prediction precision.

The present inventor has found out that the reason is that a function obtained by the remaining-value prediction system does not necessarily describe a used-article circulating price in a sufficient manner.

The remaining-value prediction system obtains a function by fitting an exponential function or the like to each used car classified in accordance with color and the like. However, a processing procedure employed by the remaining-value prediction system is a predetermined procedure, and is not necessarily an optimal procedure for predicting a used-article circulating price. Accordingly, a function obtained by the remaining-value prediction system does not sufficiently describe a used-article circulating price.

The remaining-value prediction system disclosed in PTL 1 is not able to automatically find out what classification is optimal, and further, is not able to assign an optimal formula to a discovered classification. For example, the remaining-value prediction system has a problem that precision deteriorates when an optimal classification method varies with type, or an optimal formula varies with respective classification targets.

When using the remaining-value prediction system, an optimal classification needs to be discovered by trying and failing every classification, in order to reduce the precision deterioration. However, when using the remaining-value prediction system, discovering an optimal classification by trying and failing takes enormous time. In other words, the remaining-value prediction system also has a problem that discovery of an optimal classification takes enormous time.

The applicant of the present invention has come to find out such problems and to derive a means for solving such problems. Exemplary embodiments of the present invention capable of solving such problems will be described in detail below with reference to the drawings.

A price being a prediction target is, for example, a price of a used building, a used car, a used device, a used game machine, used clothes, and the like. Further, a price being a prediction target is, for example, a purchase price at which a broker mediating a trade buys, and a sales price at which a broker sells.

For convenience of description, it is hereinafter assumed in the respective exemplary embodiments that a price related to a used device is predicted. However, a prediction target is not limited to a price of a used device and the like.

A learning database includes a plurality of sets of data related to a used device and a price.

The hierarchical latent variable model referred to in this description is defined as a probability model having latent variables represented by a hierarchical structure (for example, tree structure). Components representing probability models are assigned to the nodes at the lowest level of the hierarchical latent variable model. Gating functions (gating function models) for selecting nodes in accordance with input information are allocated to nodes (immediate nodes; to be referred to as “branch nodes”, for the sake of convenience in taking a tree structure as an example) other than the nodes at the lowest level.

A process by a price estimation device and other details will be described hereinafter with reference to a two-level hierarchical latent variable model taken as example. For the sake of descriptive convenience, the hierarchical structure is assumed to be a tree structure. However, in the present invention to be set forth by taking the following exemplary embodiments as an example, the hierarchical structure is not always a tree structure.

When the hierarchical structure is assumed to be a tree structure, course from the root node to a certain node is only one because the tree structure has no loop (cycle). The course (link) from the root node to a certain node in the hierarchical latent structure will be referred to as a “path” hereinafter. Path latent variables are determined by tracing the latent variables for each path. For example, a lowest-level path latent variable is defined as a path latent variable determined for each path from the root node to the node at the lowest level.

The following description assumes that a data sequence xⁿ (n=N) is input. It is assumed that each xⁿ is defined as an M-dimensional multivariate data sequence (xⁿ=x₁ⁿ, . . . , x_{M}ⁿ). The data sequence xⁿ also sometimes serves as an observation variable. A first-level branch latent variable z₁ⁿ, a lowest-level branch latent variable zⱼₗᵢⁿ, and a lowest-level path latent variable zᵢⱼⁿ for the observation variable xⁿ are defined as follows.

zᵢⁿ=1 indicates that a branch of xⁿ input to the root node to the i-th node at the first level takes place. zᵢⁿ=0 indicates that no branch to the i-th node at the first level takes place. zⱼₗᵢⁿ=1 indicates that a branch of xⁿ input to the i-th node at the first level to the j-th node at the second level takes place. zⱼₗᵢⁿ=0 indicates that no branch to the j-th node at the second level takes place when a node is selected based on xⁿ input to the i-th node at the first level. zᵢⱼⁿ=1 indicates that a branch of xⁿ input to a component traced by passing through the i-th node at the first level and the j-th node at the second level takes place. zᵢⱼⁿ=0 indicates that no branch of xⁿ input to a component traced by passing through the i-th node at the first level and the j-th node at the second level takes place.

Since Σᵢzᵢⁿ=1, Σⱼzⱼₗᵢⁿ=1, and zᵢⱼⁿ=zᵢⁿ·zⱼₗᵢⁿ are satisfied, we have zᵢⁿ=Σⱼzᵢⱼⁿ. A combination of x and the representative value z of the lowest-level path latent variable zᵢⱼⁿ is called a “complete variable.” In contrast to this, x is called an incomplete variable.

Eqn. 1 represents a hierarchical latent variable model joint distribution of depth 2 for a complete variable.

$$\begin{matrix}p ( {x}^{N} , {z}^{N} \vert M ) = p ( {x}^{N} , {z}_{1 st}^{N} , {z}_{2 nd}^{N} \vert M ) \\ = \int {\prod }_{n = 1}^{N} \{ p ( {z}_{1 st}^{n} \vert β ) {\prod }_{i = 1}^{{K}_{1}} {p ( {z}_{2 nd \vert i}^{n} \vert {β}_{i} )}^{{x}_{i}^{n}} \\ {\prod }_{i = 1}^{{K}_{1}} {\prod }_{j = 1}^{{K}_{2}} {p ( {x}^{n} \vert {φ}_{ij} )}^{{z}_{i}^{n} {z}_{j \vert i}^{n}} \} d θ\end{matrix} \qquad ( Eqn . 1 )$$

In other words, P(x, y)=P(x, z₁ₛₜ, z_{2nd}) in Eqn. 1 defines a hierarchical latent variable model joint distribution of depth 2 for a complete variable. In Eqn. 1, z₁ₛₜⁿ is the representative value of zᵢⁿ and z_{2nd}ⁿ is the representative value of zⱼₗᵢⁿ. The variational distribution for the first-level branch latent variable zᵢⁿ is represented as q(zᵢⁿ) and the variational distribution for the lowest-level path latent variable zᵢⱼⁿ is represented as q(zᵢⱼⁿ).

In Eqn. 1, K₁ is the number of nodes in the first level and K₂ is the number of nodes branched from each node at the first level. In this case, a component at the lowest level is expressed as Kᵢ×K₂. Let θ=(β, β₁, . . . , β_{K1}, φ₁, . . . , φ_{(K1×K2)} be the model parameter, where β is the branch parameter of the root node, βₖ is the branch parameter of the k-th node at the first level, and βₖ is the observation parameter for the k-th component.

A hierarchical latent variable model of depth 2 will be taken as a specific example hereinafter. However, the hierarchical latent variable model according to at least one exemplary embodiment is not limited to a hierarchical latent variable model of depth 2 and may be defined as a hierarchical latent variable model of depth 1 or 3 or more. In this case, as well as a hierarchical latent variable model of depth 2, Eqn. 1 and Eqns. 2 to 4 (to be described later) need only be derived, thereby implementing an estimation device with a similar configuration.

A distribution having X as a target variable will be described hereinafter. However, the same applies to the case where the observation distribution serves as a conditional model P(Y|X) (Y is the target probability variable), as in regression or classification.

Before a description of exemplary embodiments, the essential difference between an estimation device according to any of these exemplary embodiments and the estimation method for a mixture latent variable model described in NPL 1 will be described below.

The method disclosed in NPL 1 assumes a general mixture model having the latent variable as an indicator for each component. Then, an optimization criterion is derived, as presented in Eqn. 10 of NPL 1. However, given a Fisher information matrix expressed as Eqn. 6 in NPL 1, the method described in NPL 1 postulates that the probability distribution of the latent variable serving as an indicator for each component depends only on the mixture ratio in the mixture model. Therefore, since the components cannot be switched in accordance with input, this optimization criterion is inappropriate.

To solve this problem, it is necessary to set hierarchical latent variables and perform computation involved in accordance with an appropriate optimization criterion, as will be shown in the following exemplary embodiments. The following exemplary embodiments assume that a multi-level singular model for selecting branches at respective branch nodes in accordance with input is used as such an appropriate optimization criterion.

Exemplary embodiments will be described below with reference to the accompanying drawings.

### First Exemplary Embodiment

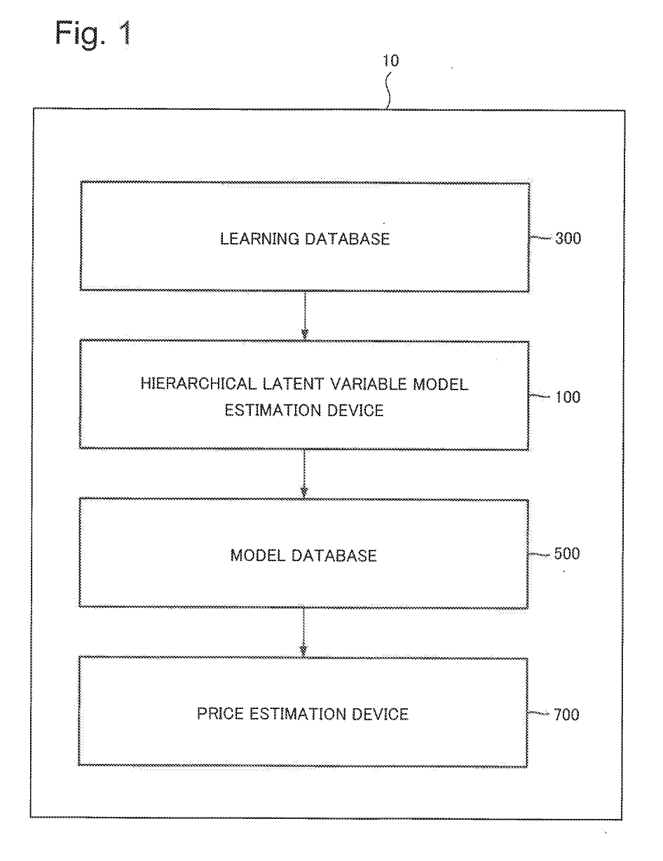

FIG. 1 is a block diagram illustrating an exemplary configuration of a price estimation system according to at least one exemplary embodiment of the present invention.

A price prediction system 10 according to this exemplary embodiment includes an estimation device 100 of a hierarchical latent variable model (a hierarchical latent variable model estimation device 100), a learning database 300, a model database 500, and a price prediction device 700. The price prediction system 10 generates a model for predicting the price based on information concerning the price to predict the price using the model.

The hierarchical latent variable model estimation device 100 estimates a model for estimating (predicting) the price using data stored in the learning database 300 and stores the model in the model database 500.

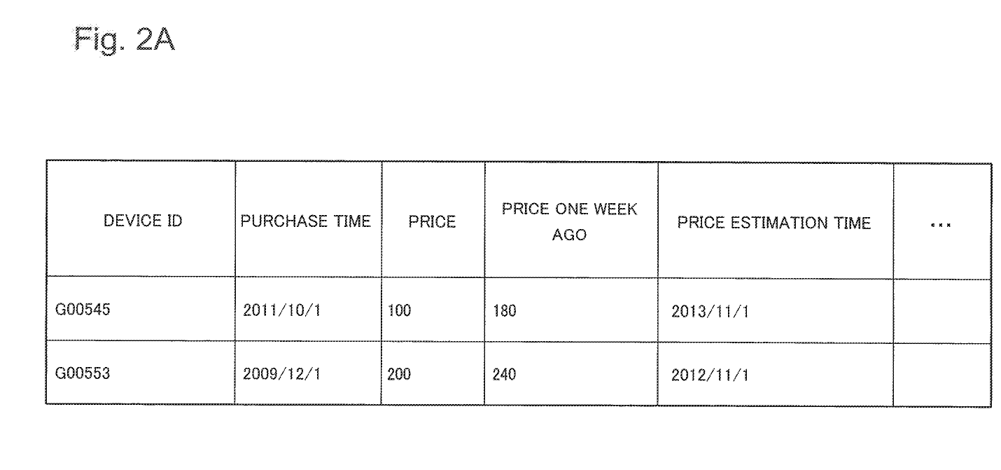

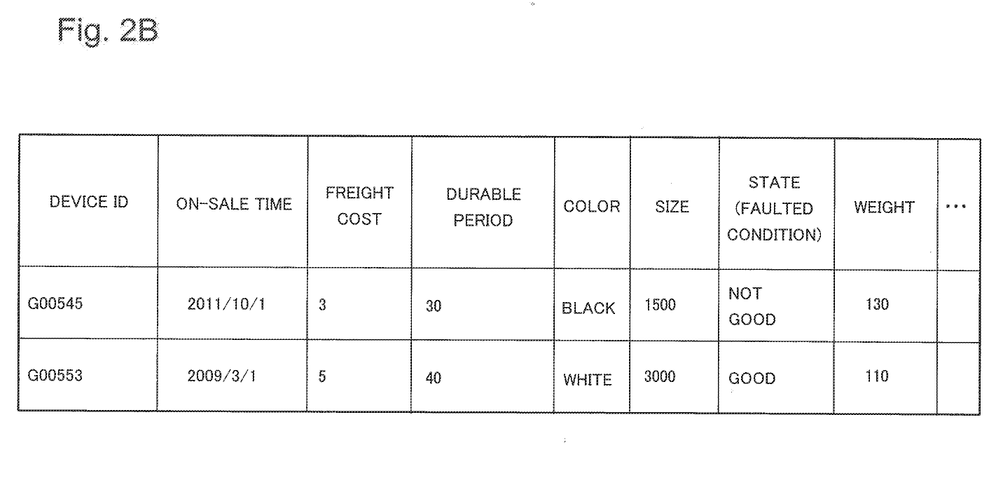

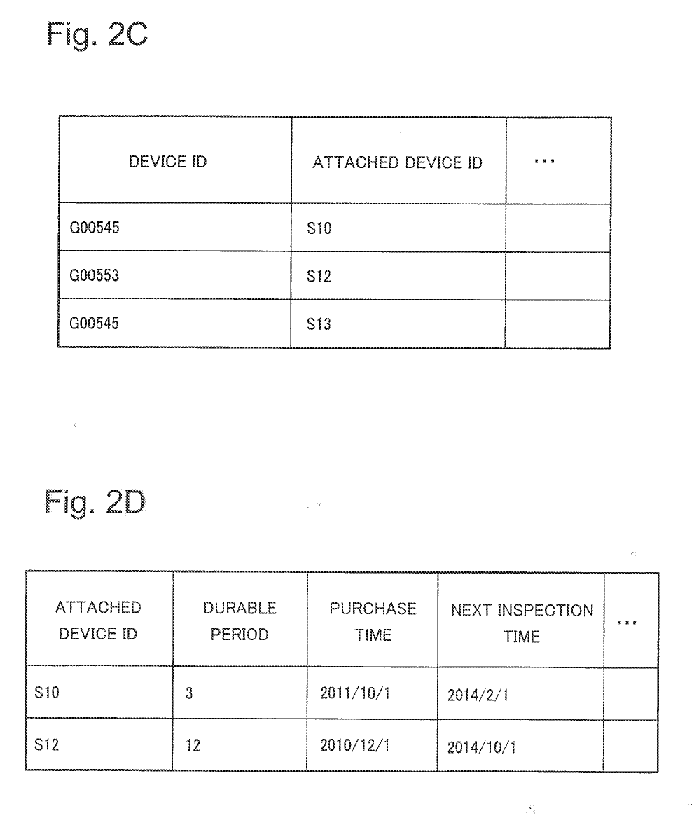

FIG. 2A to FIG. 2D is a table illustrating an example of information stored in a learning database according to at least one exemplary embodiment of the present invention.

Price information associated with a price and a factor potentially influencing the price is stored in the learning database 300. As exemplified in FIG. 2A, a device identifier (ID) is associated with a price, a purchase time, a price measurement time, and the like in the price information.

Further, device information storing data related to a device is stored in the learning database 300. As shown in FIG. 2B, the device information includes an on-sale date, a freight cost, a durable period, a color, a size, a faulted condition, a weight, and the like associated with a device ID.

Further, device configuration information storing data related to an attached device attached to a device is stored in the learning database 300. As illustrated in FIG. 2C, the device configuration information includes a device ID associated with an attached device ID attached to the device.

Further, attached device information including data related to an attached device is stored in the learning database 300. As illustrated in FIG. 2D, the attached device information includes an attached device ID associated with a durable period, a purchase time, a next inspection time, and the like.

Learning data may be generated by combining values included in the learning database 300, or the like. The learning data may be generated by applying an operation to a value included in the learning database 300. Alternatively, the learning data may be generated by synthesizing the aforementioned two operations.

Information included in the learning database is not limited to the aforementioned example.

When a target object is a used car, the learning database 300 may include, for example, information such as a displacement, accessory information, a mileage, and a manufacturer, an on-sale year, remaining months to vehicle inspection, a model, or a grade. The learning database 300 may include an item other than the aforementioned items, and is not necessarily required to include all of the aforementioned items.

Further, when a target object is a used home, the learning database 300 may include, for example, information such as a distance from a station, a gross floor area, a floor number, a number of stories, a distance from a park, a distance from a school, a distance from a supermarket, whether or not a bath and a toilet are separated, whether or not an automatic lock is furnished, whether or not an elevator is furnished, a storage area, or a floor plan. The learning database 300 may include an item other than the aforementioned items, and is not necessarily required to include all of the aforementioned items.

The model database 500 stores a model for predicting the price estimated by the hierarchical latent variable model estimation device 100. The model database 500 is implemented with a non-transitory tangible medium such as a hard disk drive or a solid-state drive.

The price prediction device 700 receives data associated with a price related to a building and predicts the price based on these data and the model stored in the model database 500.

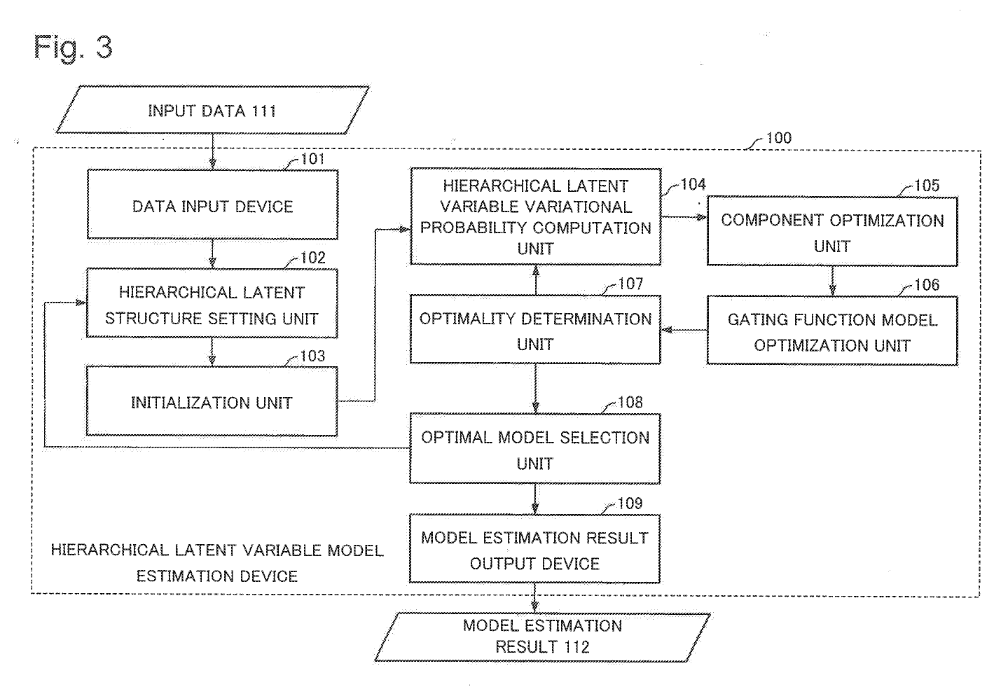

FIG. 3 is a block diagram illustrating an exemplary configuration of the hierarchical latent variable model estimation device according to at least one exemplary embodiment. The hierarchical latent variable model estimation device 100 according to this exemplary embodiment includes a data input device 101, a setting unit 102 of a hierarchical latent structure (a hierarchical latent structure setting unit 102), an initialization unit 103, a calculation processing unit 104 of a variational probability of a hierarchical latent variable (a hierarchical latent variable variational probability computation unit 104), and an optimization unit 105 of a component (a component optimization unit 105). The hierarchical latent variable model estimation device 100 further includes an optimization unit 106 of a gating function (a gating function model optimization unit 106), an optimality determination unit 107, an optimal model selection unit 108, and an output device 109 of a model estimation result (a model estimation result output device 109).

Upon receiving input data 111 generated based on the data stored in the learning database 300, the hierarchical latent variable model estimation device 100 optimizes the hierarchical latent structure and the type of observation probability for the input data 111. The hierarchical latent variable model estimation device 100 then outputs the optimization result as a model estimation result 112 and stores the model estimation result 112 into the model database 500. In this exemplary embodiment, the input data 111 exemplifies learning data.

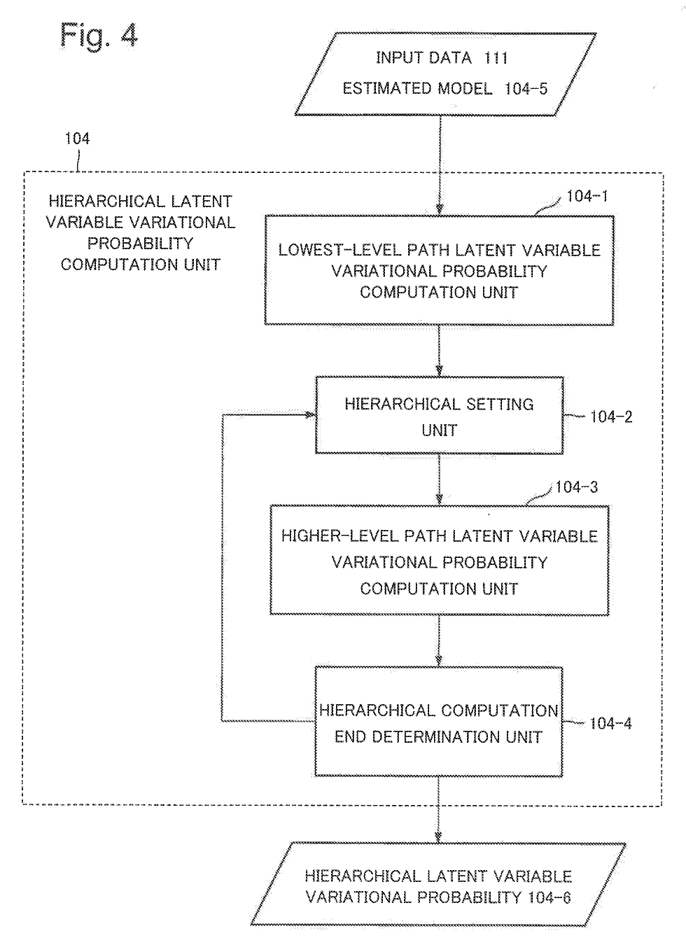

FIG. 4 is a block diagram illustrating an exemplary configuration of the hierarchical latent variable variational probability computation unit 104 according to at least one exemplary embodiment of the present invention. The hierarchical latent variable variational probability computation unit 104 includes a calculation processing unit 104-1 of a variational probability of a lowest-level path latent variable (a lowest-level path latent variable variational probability computation unit 104-1), a hierarchical setting unit 104-2, a calculation processing unit 104-3 of a variational probability of a higher-level path latent variable (a higher-level path latent variable variational probability computation unit 104-3), and a determination unit 104-4 of an end of a hierarchical calculation processing (a hierarchical computation end determination unit 104-4).

The hierarchical latent variable variational probability computation unit 104 outputs a hierarchical latent variable variational probability 104-6 in accordance with the input data 111, and an estimated model 104-5 in the component optimization unit 105 for a component (to be described later). The hierarchical latent variable variational probability computation unit 104 will be described in more detail later. The component in this exemplary embodiment is defined as a value indicating the weight (parameter) applied to each explanatory variable. The price prediction device 700 can obtain a target variable by computing the sum of explanatory variables each multiplied by the weight indicated by the component.

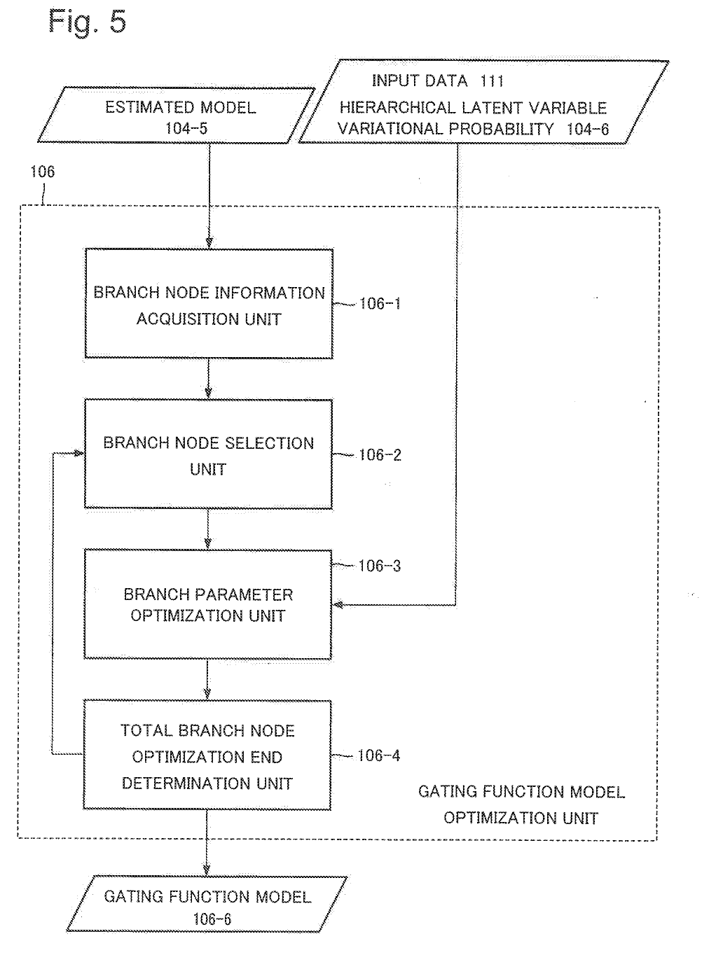

FIG. 5 is a block diagram illustrating an exemplary configuration of the gating function model optimization unit 106 according to at least one exemplary embodiment of the present invention. The gating function model optimization unit 106 includes an information acquisition unit 106-1 of a branch node (a branch node information acquisition unit 106-1), a selection unit 106-2 of a branch node (a branch node selection unit 106-2), an optimization unit 106-3 of a branch parameter (a branch parameter optimization unit 106-3), and a determination unit 106-4 of an end of optimization of a total branch node (a total branch node optimization end determination unit 106-4).

The gating function model optimization unit 106 receive the input data 111, a hierarchical latent variable variational probability 104-6, that is calculated by a hierarchical latent variable variational probability computation unit 104 (to be described later), and an estimated model 104-5, that is estimated by a component optimization unit 105 (to be described later). The gating function model optimization unit 106 outputs a gating function model 106-6 in accordance with the three inputs. The gating function model optimization unit 106 will be descried in more detail later. The gating function in this exemplary embodiment is used to determine whether the information in the input data 111 satisfies a predetermined condition. The gating function model is set at internal nodes of the hierarchical latent structure. The internal nodes indicates nodes except nodes at the lowest level. In tracing the path from the root node to the node at the lowest level, the price prediction device 700 determines a node to be traced next in accordance with the determination result based on the gating function model.

The data input device 101 is a device inputting the input data 111. The data input device 101 computes a target variable representing a price on the basis of data recorded in the price information in the learning database 300.

Further, the data input device 101 generates explanatory variables on the basis of data recorded in the price information, the device information, the device configuration information, the attached device information, and the like, in the learning database 300. Specifically, the data input device 101 generates one or more explanatory variables being information potentially influencing the target variable for an individual target variable. Then, the data input device 101 inputs a plurality of combinations of target variables and explanatory variables as the input data 111. When inputting the input data 111, the data input device 101 also inputs parameters required for estimating a model, such as an observation probability type and a candidate of a number of components. The data input device 101 according to the present exemplary embodiment is an example of a learning information input unit.

The hierarchical latent structure setting unit 102 selects the structure of a hierarchical latent variable model as a candidate for optimization based on the input types of observation probability and the input candidates for the number of components, and set the selected structure to a target for optimization. The latent structure used in this exemplary embodiment is a tree structure. Letting C be the set number of components. Let equations used for the following description be equations for a hierarchical latent variable model of depth 2. The hierarchical latent structure setting unit 102 may store the selected structure of a hierarchical latent variable model in a memory.

Assuming, for example, that a binary tree model (a model having a bifurcation at each branch node) is used and the depth of tree structure is 2, the hierarchical latent structure setting unit 102 selects a hierarchical latent structure having two nodes at the first level and four nodes at the second level (in this exemplary embodiment, the nodes at the lowest level).

The initialization unit 103 performs an initialization process for estimating a hierarchical latent variable model. The initialization unit 103 can perform the initialization process by an arbitrary method. The initialization unit 103 may, for example, randomly set the type of observation probability for each component and, in turn, randomly set a parameter for each observation probability in accordance with the set type. The initialization unit 103 may further randomly set a lowest-level path variational probability for the hierarchical latent variable.

The hierarchical latent variable variational probability computation unit 104 computes the path latent variable variational probability for each hierarchical level. The parameter θ is computed by the initialization unit 103 or the component optimization unit 105, the gating function model optimization unit 106 and so on. Therefore, the hierarchical latent variable variational probability computation unit 104 computes the variational probability on the basis of the obtained value.

The hierarchical latent variable variational probability computation unit 104 obtains a Laplace approximation of the marginal log-likelihood function with respect to an estimation (for example, a maximum likelihood estimate or a maximum a posteriori probability estimate) for the complete variable and maximizes its lower bound to compute the variational probability. The thus computed variational probability will be referred to as an optimization criterion A hereinafter.

The procedure of computing the optimization criterion A will be described by taking a hierarchical latent variable model of depth 2 as an example. The marginal log-likelihood function is given by:

$$log p ( {x}^{N} \vert M ) \geq {\sum }_{{Z}^{N}} q ( {z}^{N} ) log \{ \frac{p ( {x}^{N} , {z}^{N} \vert M )}{q ( {z}^{N} )} \} \qquad ( Eqn . 2 )$$

Where log represents, for example, a logarithm function. A base of the logarithm function is, for example, a Napier's value. The same applies to equations to be presented hereinafter.

The lower bound of the marginal log-likelihood function presented in Eqn. 2 will be considered first. In Eqn. 2, the equality holds true when the lowest-level path latent variable variational probability q(zⁿ) is maximized. Deriving a Laplace approximation of the marginal likelihood of the complete variable of the numerator in accordance with a maximum likelihood estimate for the complete variable yields an approximate expression of the marginal log-likelihood function given by:

$$J ( q , \overline{θ} , {x}^{N} ) = {\sum }_{{z}^{N}} q ( {z}^{N} ) \{ log p ( {x}^{N} , {z}^{N} \vert \overline{θ} ) - \frac{{D}_{β}}{2} log N - {\sum }_{i = 1}^{{K}_{1}} \frac{{D}_{{β}_{i}}}{2} log ( {\sum }_{n = 1}^{N} {\sum }_{j = 1}^{{K}_{2}} {z}_{ij}^{n} ) - {\sum }_{i = 1}^{{K}_{1}} {\sum }_{j = 1}^{{K}_{2}} \frac{{D}_{{φ}_{ij}}}{2} log ( {\sum }_{n = 1}^{N} {z}_{ij}^{n} ) - log q ( {z}^{N} ) \} \qquad ( Eqn . 3 )$$

In Eqn. 3, the bar put over the letter symbolizes the maximum likelihood estimate for the complete variable, and D_{*} is the dimension of the subscript parameter *.

On the basis of the facts that the maximum likelihood estimate has the property of maximizing the marginal log-likelihood function and that the logarithmic function is expressed as a concave function, the lower bound presented in Eqn. 3 is calculated as Eqn. 4 represented as follows.

$$g ( q , {q}^{′} , {q}^{″} , θ , {x}^{N} ) = {\sum }_{{Z}^{N}} q ( {z}^{N} ) [ log p ( {x}^{N} , {z}^{N} \vert \overline{θ} ) - \frac{{D}_{β}}{2} log N - {\sum }_{i = 1}^{{K}_{1}} \frac{{D}_{{β}_{i}}}{2} \{ log ( {\sum }_{n = 1}^{N} {q}^{′} ( {z}_{i}^{n} ) ) + \frac{{\sum }_{n = 1}^{N} {\sum }_{j = 1}^{{K}_{2}} {z}_{ij}^{n}}{{\sum }_{n = 1}^{N} {q}^{′} ( {z}_{i}^{n} )} - 1 \} - {\sum }_{i = 1}^{{K}_{1}} {\sum }_{j = 1}^{{K}_{2}} \frac{{D}_{{φ}_{ij}}}{2} \{ log ( {\sum }_{n = 1}^{N} {q}^{″} ( {z}_{ij}^{n} ) ) + \frac{{\sum }_{n = 1}^{N} {z}_{ij}^{n}}{{\sum }_{n = 1}^{N} {q}^{″} ( {z}_{ij}^{n} )} - 1 \} - log q ( {z}^{N} ) ] \qquad ( Eqn . 4 )$$

The variational distribution q′ of the first-level branch latent variable and the variational distribution q″ of the lowest-level path latent variable are calculated by maximizing Eqn. 4 for the respective variational distributions. Note that q″=q^{{t-1}} and θ=θ^{{t-1}} are fixed and q′ is fixed to a value given by Eqn. A.

$${q}^{′} = {\sum }_{j = 1}^{{K}_{2}} {q}^{\{ t - 1 \}} \qquad ( Eqn . A )$$

Note that the superscript (t) represents the t-th iteration in iterative computation of the hierarchical latent variable variational probability computation unit 104, the component optimization unit 105, the gating function model optimization unit 106, and the optimality determination unit 107.

An exemplary operation of the hierarchical latent variable variational probability computation unit 104 will be described below with reference to FIG. 4.

The lowest-level path latent variable variational probability computation unit 104-1 receives the input data 111 and the estimated model 104-5 and computes the lowest-level latent variable variational probability q(z^{N}). The hierarchical setting unit 104-2 sets the lowest level for which the variational probability is to be computed. More specifically, the lowest-level path latent variable variational probability computation unit 104-1 computes the variational probability of each estimated model 104-5 for each combination of a target variable and an explanatory variable in the input data 111. The value of the variational probability is computed by a comparison between a solution obtained by substituting the explanatory variable in the input data 111 into the estimated model 104-5 and the target variable of the input data 111.

The higher-level path latent variable variational probability computation unit 104-3 computes the path latent variable variational probability for immediately higher level. More specifically, the higher-level path latent variable variational probability computation unit 104-3 computes the sum of latent variable variational probabilities of the current level having a common branch node as a parent and sets the obtained sum as the path latent variable variational probability for immediately higher level.

The hierarchical computation end determination unit 104-4 determines whether any higher level for which the variational probability is to be computed remains. If it is determined that any higher level is present, the hierarchical setting unit 104-2 sets immediately higher level for which the variational probability is to be computed. Subsequently, the higher-level path latent variable variational probability computation unit 104-3 and the hierarchical computation end determination unit 104-4 repeat the above-mentioned processes. If it is determined that any higher level is absent, the hierarchical computation end determination unit 104-4 determines that path latent variable variational probabilities have been computed for all levels.

The component optimization unit 105 optimizes the model of each component (the parameter θ and its type S) for Eqn. 4 and outputs the optimized, estimated model 104-5. In the case of a hierarchical latent variable model of depth 2, the component optimization unit 105 fixes q and q″ to the variational probability q(t) of the lowest-level path latent variable computed by the hierarchical latent variable variational probability computation unit 104. The component optimization unit 105 further fixes q′ to the higher-level path latent variable variational probability presented in Eqn. A. The component optimization unit 105 then computes a model for maximizing the value of G presented in Eqn. 4.

Let S₁, . . . , S_{K1×K2} be the type of observation probability for φₖ. In the case of, for example, a multivariate data generation probability, examples of candidates for S₁ to S_{K1×K2} may include normal distribution, lognormal distribution, or exponential distribution. Alternatively, when, for example, a polynomial curve is output, examples of candidates for S₁ to S_{K1×K2} may include zeroth-order curve, linear curve, quadratic curve, or cubic curve.

G defined by Eqn. 4 allows decomposition of an optimization function for each component. It is, therefore, possible to independently optimize S₁ to S_{K1×K2} and the parameters φ₁ to φ_{K1×K2} with no concern for a combination of types of components (for example, designation of any of S₁ to S_{K1×K2}). In this process, importance is placed on enabling such optimization. This makes it possible to optimize the type of component while avoiding combinatorial explosion.

An exemplary operation of the gating function model optimization unit 106 will be described below with reference to FIG. 5. The branch node information acquisition unit 106-1 extracts a list of branch nodes using the estimated model 104-5 in the component optimization unit 105. The branch node selection unit 106-2 selects one branch node from the extracted list of branch nodes. The selected node will sometimes be referred to as a “selection node” hereinafter.

The branch parameter optimization unit 106-3 optimizes the branch parameter of the selection node on the basis of the input data 111 and the latent variable variational probability for the selection node obtained from the hierarchical latent variable variational probability 104-6. The branch parameter of the selection node is in the above-mentioned gating function model.

The total branch node optimization end determination unit 106-4 determines whether all branch nodes extracted by the branch node information acquisition unit 106-1 have been optimized. If all branch nodes have been optimized, the gating function model optimization unit 106 ends the process in this sequence. If all branch nodes have not been optimized, a process is performed by the branch node selection unit 106-2 and subsequent processes are performed by the branch parameter optimization unit 106-3 and the total branch node optimization end determination unit 106-4.

The gating function will be described hereinafter by taking, as a specific example, a gating function based on the Bernoulli distribution for a binary tree hierarchical model. A gating function based on the Bernoulli distribution will sometimes be referred to as a “Bernoulli gating function” hereinafter. Let x_{d} be the d-th dimension of x, g− be the probability of a branch of the binary tree to the lower left when this value is equal to or smaller than a threshold w, and g+ be the probability of a branch of the binary tree to the lower left when this value is larger than the threshold w. The branch parameter optimization unit 106-3 optimizes the above-mentioned optimization parameters d, w, g−, and g+ based on the Bernoulli distribution. This enables more rapid optimization because each parameter has an analytic solution, differently from the gating function based on the logit function described in NPL 1.

The optimality determination unit 107 determines whether the optimization criterion A computed using Eqn. 4 has converged. If the optimization criterion A has not converged, the processes by the hierarchical latent variable variational probability computation unit 104, the component optimization unit 105, the gating function model optimization unit 106, and the optimality determination unit 107 are repeated. The optimality determination unit 107 may determine that the optimization criterion A has converged when, for example, the increment of the optimization criterion A is smaller than a predetermined threshold.

The processes by the hierarchical latent variable variational probability computation unit 104, the component optimization unit 105, the gating function model optimization unit 106, and the optimality determination unit 107 will sometimes simply be referred to hereinafter as a first processes. An appropriate model can be selected by repeating the first process and updating the variational distribution and the model. Repeating these processes ensures monotone increasing of the optimization criterion A.

The optimal model selection unit 108 selects an optimal model. Assume, for example, that the optimization criterion A computed in the first process is larger than the currently set optimization criterion A, for the number of hidden states set by the hierarchical latent structure setting unit 102. Then, the optimal model selection unit 108 selects the model as an optimal model.

The model estimation result output device 109 optimizes the model with regard to candidates for the structure of a hierarchical latent variable model set from the input type of observation probability and the input candidates for the number of components. If the optimization is complete, the model estimation result output device 109 outputs, for example, the number of optimal hidden states, the type of observation probability, the parameter, and the variational distribution as a model estimation result 112. If any candidate remains to be optimized, the hierarchical latent structure setting unit 102 similarly performs the above-mentioned processes.

The central processing unit (to be abbreviated as the “CPU” hereinafter) of a computer operating in accordance with a program (hierarchical latent variable model estimation program) implements the following respective units:
the hierarchical latent structure setting unit 102;
the initialization unit 103;
the hierarchical latent variable variational probability computation unit 104 (more specifically, the lowest-level path latent variable variational probability computation unit 104-1, the hierarchical setting unit 104-2, the higher-level path latent variable variational probability computation unit 104-3, and the hierarchical computation end determination unit 104-4);
the component optimization unit 105;
the gating function model optimization unit 106 (more specifically, the branch node information acquisition unit 106-1, the branch node selection unit 106-2, the branch parameter optimization unit 106-3, and the total branch node optimization end determination unit 106-4);
the optimality determination unit 107; and
the optimal model selection unit 108.

For example, the program is stored in a storage unit (not illustrated) of the hierarchical latent variable model estimation device 100, and the CPU reads this program and executes the processes in accordance with this program, in the following respective units:
the hierarchical latent structure setting unit 102;
the initialization unit 103;
the hierarchical latent variable variational probability computation unit 104 (more specifically, the lowest-level path latent variable variational probability computation unit 104-1, the hierarchical setting unit 104-2, the higher-level path latent variable variational probability computation unit 104-3, and the hierarchical computation end determination unit 104-4);
the component optimization unit 105;
the gating function model optimization unit 106 (more specifically, the branch node information acquisition unit 106-1, the branch node selection unit 106-2, the branch parameter optimization unit 106-3, and the total branch node optimization end determination unit 106-4);
the optimality determination unit 107; and
the optimal model selection unit 108.

Dedicated hardware may be used to implement the following respective units:
the hierarchical latent structure setting unit 102;
the initialization unit 103;
the hierarchical latent variable variational probability computation unit 104;
the component optimization unit 105;
the gating function model optimization unit 106;
the optimality determination unit 107; and
the optimal model selection unit 108.

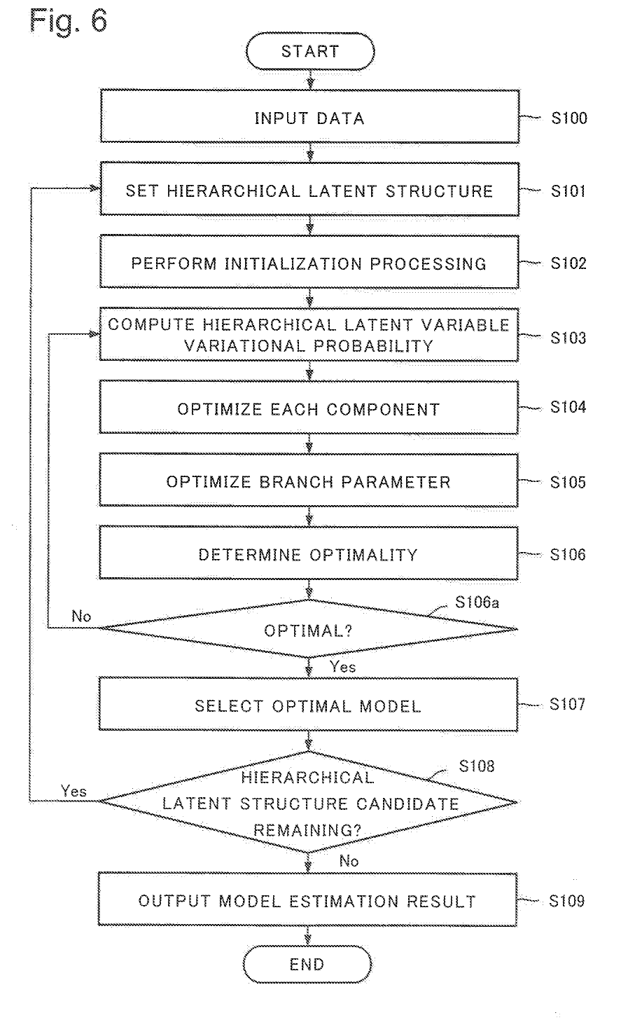

An exemplary operation of the hierarchical latent variable model estimation device according to this exemplary embodiment will be described below. FIG. 6 is a flowchart illustrating an exemplary operation of the hierarchical latent variable model estimation device according to at least one exemplary embodiment of the present invention.

The data input device 101 receives input data 111 first (step S100). The hierarchical latent structure setting unit 102 then selects a hierarchical latent structure remaining and set the selected structure to be optimized in the input candidate values of the hierarchical latent structure (step S101). The initialization unit 103 initializes the latent variable variational probability and the parameters used for estimation, for the set hierarchical latent structure (step S102).

The hierarchical latent variable variational probability computation unit 104 computes each path latent variable variational probability (step S103). The component optimization unit 105 optimize each component by estimating the type of observation probability and the parameters (step S104).

The gating function model optimization unit 106 optimizes the branch parameter of each branch node (step S105). The optimality determination unit 107 determines whether the optimization criterion A has converged or not (step S106). In other words, the optimality determination unit 107 determines the model optimality.

If it is determined in step S106 that the optimization criterion A has not converged (that is, determined that the model is not optimal) (NO in step S106a), the processes in steps S103 to S106 are repeated.

If it is determined in step S106 that the optimization criterion A has converted (that is, determined that the model is optimal) (YES in step S106a), the optimal model selection unit 108 performs the following process. In other words, the optimal model selection unit 108 compares the optimization criterion A obtained based on the currently set optimal model (for example, the number of components, the type of observation probability, and the parameters) and the value of the optimization criterion A obtained based on the model currently set as an optimal model. The optimal model selection unit 108 selects a model having a larger value as an optimal model (step S107).

The optimal model selection unit 108 determines whether any candidate for the hierarchical latent structure remains to be estimated or not (step S108). If any candidate remains (Yes in step S108), the processes in steps S101 to S108 are repeated. If no candidate remains (No in step S108), the model estimation result output device 109 outputs a model estimation result and ends the process (step S109). The model estimation result output device 109 stores the component optimized by the component optimization unit 105 and the gating function model optimized by the gating function model optimization unit 106 into the model database 500.

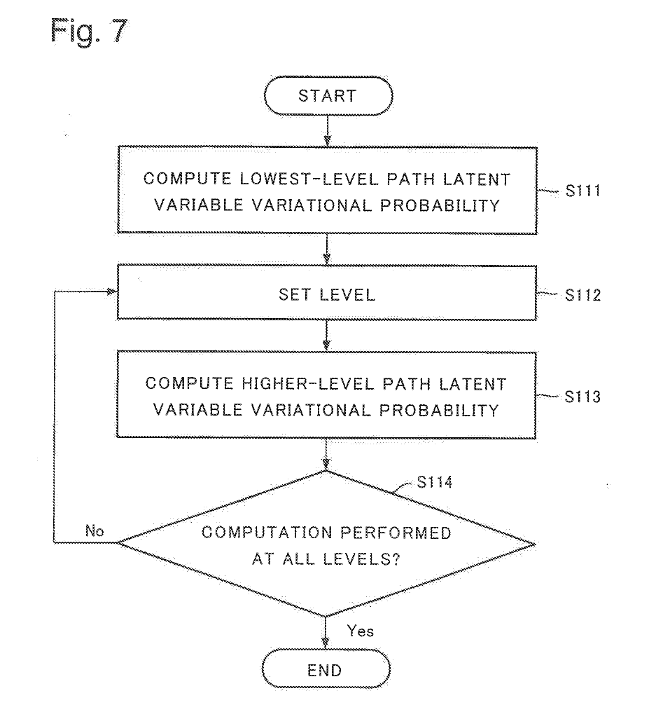

An exemplary operation of the hierarchical latent variable variational probability computation unit 104 according to this exemplary embodiment will be described below. FIG. 7 is a flowchart illustrating an exemplary operation of the hierarchical latent variable variational probability computation unit 104 according to at least one exemplary embodiment of the present invention.

The lowest-level path latent variable variational probability computation unit 104-1 computes the lowest-level path latent variable variational probability (step S111). The hierarchical setting unit 104-2 sets the latest level for which the path latent variable has been computed (step S112). The higher-level path latent variable variational probability computation unit 104-3 computes the path latent variable variational probability for immediately higher level on the basis of the path latent variable variational probability for the level set by the hierarchical setting unit 104-2 (step S113).

The hierarchical computation end determination unit 104-4 determines whether path latent variables have been computed for all levels (step S114). If any level for which the path latent variable is to be computed remains (No in step S114), the processes in steps S112 and S113 are repeated. If path latent variables have been computed for all levels (Yes in step S114), the hierarchical latent variable variational probability computation unit 104 ends the process.

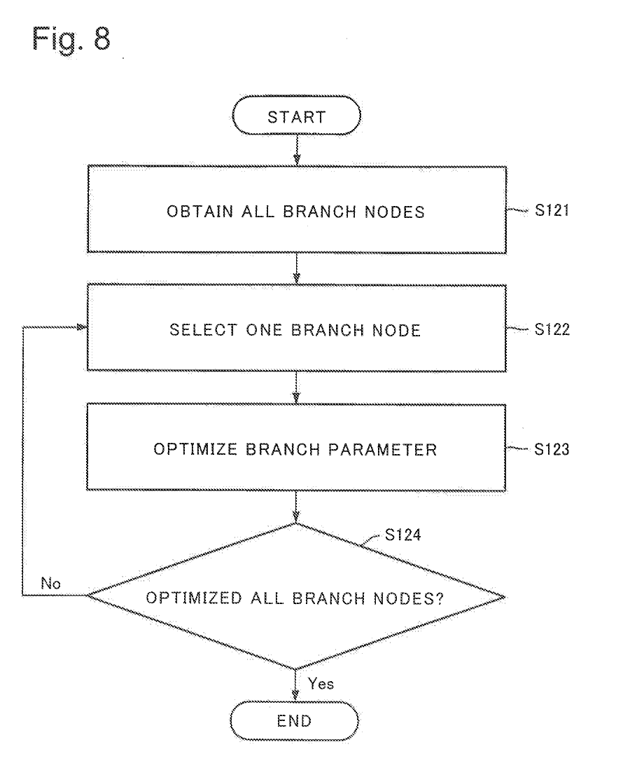

An exemplary operation of the gating function model optimization unit 106 according to this exemplary embodiment will be described below. FIG. 8 is a flowchart illustrating an exemplary operation of the gating function model optimization unit 106 according to at least one exemplary embodiment of the present invention.

The branch node information acquisition unit 106-1 obtains all branch nodes (step S121). The branch node selection unit 106-2 selects one branch node to be optimized (step S122). The branch parameter optimization unit 106-3 optimizes the branch parameters of the selected branch node (step S123).

The total branch node optimization end determination unit 106-4 determines whether any branch node remains to be optimized (step S124). If any branch node remains to be optimized (No in step S124), the processes in steps S122 and S123 are repeated. If no branch node remains to be optimized (Yes in step S124), the gating function model optimization unit 106 ends the process.

As described above, according to this exemplary embodiment, the hierarchical latent structure setting unit 102 sets a hierarchical latent structure. In the hierarchical latent structure, latent variables are represented by a hierarchical structure (tree structure) and components representing probability models are assigned to the nodes at the lowest level of the hierarchical structure. The hierarchical structure has a structure where one or more nodes are set at each hierarchy and the structure that includes a course between nodes in the first hierarchy and nodes in immediately lower second hierarchy.

The hierarchical latent variable variational probability computation unit 104 computes the path latent variable variational probability (that is, the optimization criterion A). The hierarchical latent variable variational probability computation unit 104 may compute the latent variable variational probabilities in turn from the nodes at the lowest level, for each level of the hierarchical structure. Further, the hierarchical latent variable variational probability computation unit 104 may compute the variational probability so as to maximize the marginal log-likelihood.

The component optimization unit 105 optimizes the components for the computed variational probability. The gating function model optimization unit 106 optimizes the gating functions on the basis of the latent variable variational probability at each node of the hierarchical latent structure. The gating function model serves as a model for determining a branch direction in accordance with the multivariate data at the node of the hierarchical latent structure.

Since a hierarchical latent variable model for multivariate data is estimated using the above-mentioned configuration, a hierarchical latent variable model including hierarchical latent variables can be estimated with an adequate amount of computation without losing theoretical justification. Further, the use of the hierarchical latent variable model estimation device 100 obviates the need to manually set a criterion appropriate to select components.

The hierarchical latent structure setting unit 102 sets a hierarchical latent structure having latent variables represented in, for example, a binary tree structure. The gating function model optimization unit 106 may optimize the gating function model based on the Bernoulli distribution, on the basis of the latent variable variational probability at the node. This enables more rapid optimization because each parameter has an analytic solution.

With these processes, the hierarchical latent variable model estimation device 100 determines components to predict a price for the input data 111, such as a price model defined by a parameter of temperature, a model defined according to a time zone, and an model defined a according to operational dates, on the basis of the values of the explanatory variables in the input data 111.

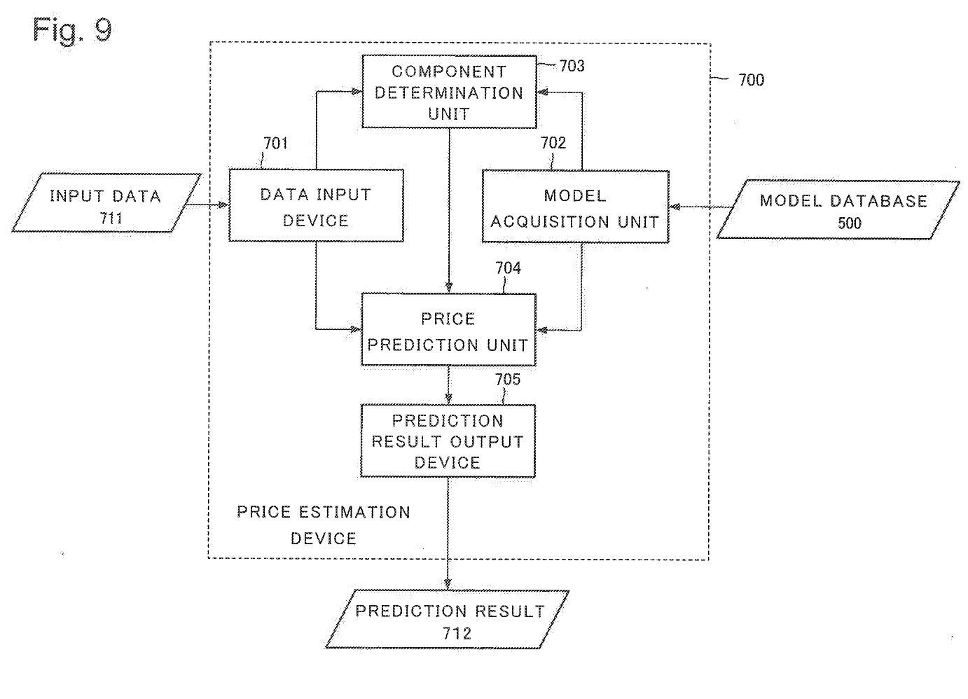

The price prediction device 700 according to this exemplary embodiment will be described below. FIG. 9 is a block diagram illustrating an exemplary configuration of the price prediction device 700 according to at least one exemplary embodiment of the present invention.

The price prediction device 700 includes a data input device 701, a model acquisition unit 702, a component determination unit 703, a price prediction unit 704, and an output device 705 of a result of prediction.

The data input device 701 receives, as input data 711, at least one explanatory variable that is information expected to influence the price. The input data 711 is formed by the same types of explanatory variables as those forming the input data 111. In this exemplary embodiment, the data input device 701 exemplifies a prediction data input unit.

The model acquisition unit 702 reads a gating function model and a component from the model database 500 as a prediction model for the price. The gating function model is optimized by the gating function model optimization unit 106. The component is optimized by the component optimization unit 105.

The component determination unit 703 traces the hierarchical latent structure on the basis of the input data 711 input to the data input device 701 and the gating function model read by the model acquisition unit 702. The component determination unit 703 selects a component associated with the node at the lowest level of the hierarchical latent structure as a component for predicting a price.

The price prediction unit 704 predicts the price by substituting the input data 711 input to the data input device 701 into the component selected by the component determination unit 703. The prediction result output device 705 outputs a prediction result 712 for the price estimated by the price prediction unit 704.

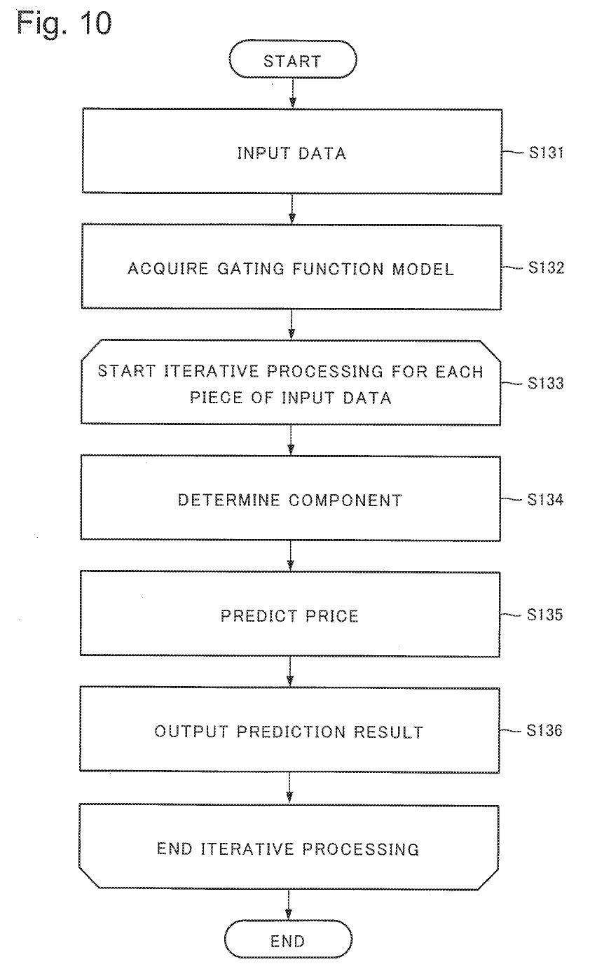

An exemplary operation of the price prediction device 700 according to this exemplary embodiment will be described below. FIG. 10 is a flowchart illustrating an exemplary operation of the price prediction device 700 according to at least one exemplary embodiment of the present invention.

The data input device 701 receives input data 711 first (step S131). The data input device 701 may receive a plurality of input data 711 instead of only one input data 711 (in each exemplary embodiment of the present invention, input data is a dataset of data (a set of information)). For example, the data input device 701 may receive input data 711 for every equipment. When the data input device 701 receives a plurality of input data 711, the price prediction unit 704 predicts the price for each input data 711. The model acquisition unit 702 acquires a gating function and a component from the model database 500 (step S132).

The price prediction device 700 selects the input data 711 one by one and performs the following processes in steps S134 to S136 for the selected input data 711 (step S133).

The component determination unit 703 selects a component for predicting the price by tracing the path from the root node to the node at the lowest level in the hierarchical latent structure in accordance with the gating function model acquired by the model acquisition unit 702 (step S134). More specifically, the component determination unit 703 selects a component in accordance with the following procedure.

The component determination unit 703 reads, for each node of the hierarchical latent structure, a gating function model associated with this node. The component determination unit 703 determines whether the input data 711 satisfies the read gating function model. The component determination unit 703 determines the node to be traced next in accordance with the determination result. Upon reaching the node at the lowest level through the nodes of the hierarchical latent structure by this process, the component determination unit 703 selects a component associated with this node as a component for prediction of the price.

When the component determination unit 703 selects a component for predicting the price in step S134, the price prediction unit 704 predicts the price by substituting the input data 711 selected in step S133 into the component (step S135). The prediction result output device 705 outputs a prediction result 712 for the price obtained by the price prediction unit 704 (step S136).

The price prediction device 700 performs the processes in steps S134 to S136 for all input data 711 and ends the process.

As described above, according to this exemplary embodiment, the price prediction device 700 can accurately estimate the price using an appropriate component on the basis of the gating function. In particular, since the gating function and the component are estimated by the hierarchical latent variable model estimation device 100 without losing theoretical justification, the price prediction device 700 can predict the price using components selected in accordance with an appropriate criterion.

### Second Exemplary Embodiment

A second exemplary embodiment of a price prediction system will be described next. The price prediction system according to this exemplary embodiment is different from the price prediction system 10 in that in the former, the hierarchical latent variable model estimation device 100 is replaced with an estimation device 200 of a hierarchical latent variable model (a hierarchical latent variable model estimation device 200).

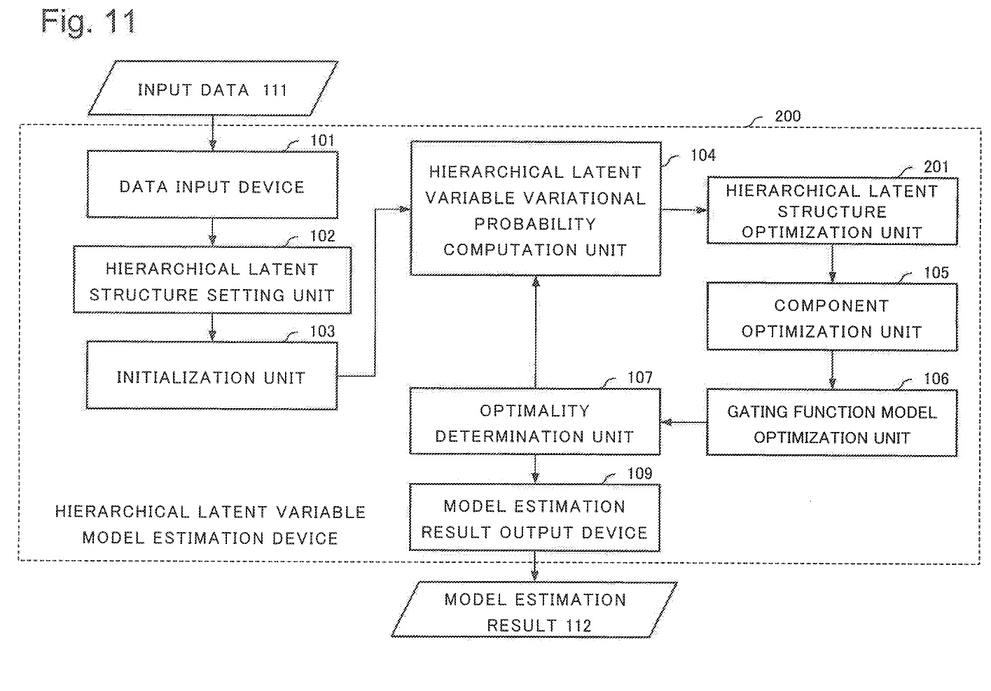

FIG. 11 is a block diagram illustrating an exemplary configuration of a hierarchical latent variable model estimation device according to at least one exemplary embodiment. The same reference numerals as in FIG. 3 denote the same configurations as in the first exemplary embodiment, and a description thereof will not be given. The hierarchical latent variable model estimation device 200 according to this exemplary embodiment is different from the hierarchical latent variable model estimation device 100 in that an optimization unit 201 of a hierarchical latent structure (a hierarchical latent structure optimization unit 201) is connected to the former while the optimal model selection unit 108 is not connected to the former.

In the first exemplary embodiment, the hierarchical latent variable model estimation device 100 optimizes the model of the component and the gating function model with regard to candidates for the hierarchical latent structure to select a hierarchical latent structure which maximizes the optimization criterion A. On the other hand, with the hierarchical latent variable model estimation device 200 according to this exemplary embodiment, a process for removing, by the hierarchical latent structure optimization unit 201, a path having its latent variable reduced from the model is added to the subsequent stage of the process by a hierarchical latent variable variational probability computation unit 104.

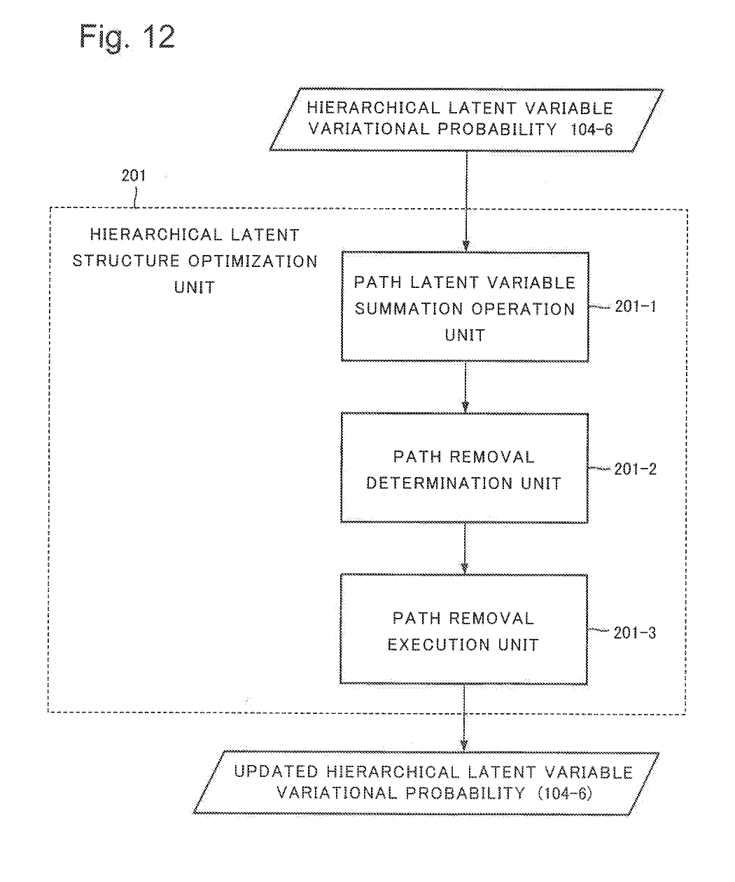

FIG. 12 is a block diagram illustrating an exemplary configuration of the hierarchical latent structure optimization unit 201 according to at least one exemplary embodiment. The hierarchical latent structure optimization unit 201 includes a summation operation unit 201-1 of a path latent variable (a path latent variable summation operation unit 201-1), a determination unit 201-2 of path removal (a path removal determination unit 201-2), and a removal execution unit 201-3 of a path (a path removal execution unit 201-3).

The path latent variable summation operation unit 201-1 receives a hierarchical latent variable variational probability 104-6 and computes the sum (to be referred to as the “sample sum” hereinafter) of lowest-level path latent variable variational probabilities in each component.

The path removal determination unit 201-2 determines whether the sample sum is equal to or smaller than a predetermined threshold c. The threshold c is input together with input data 111. More specifically, a condition determined by the path removal determination unit 201-2 can be expressed as, for example:

$${\sum }_{n = 1}^{N} q ( {z}_{ij}^{n} ) \leq ɛ \qquad ( Eqn . 5 )$$

More specifically, the path removal determination unit 201-2 determines whether the lowest-level path latent variable variational probability q(zᵢⱼⁿ) in each component satisfies the criterion presented in Eqn. 5. In other words, the path removal determination unit 201-2 determines whether the sample sum is sufficiently small.

The path removal execution unit 201-3 sets the variational probability of a path determined to have a sufficiently small sample sum to zero. The path removal execution unit 201-3 recomputes and outputs a hierarchical latent variable variational probability 104-6 at each hierarchical level on the basis of the lowest-level path latent variable variational probability normalized for the remaining paths (that is, paths whose variational probability is not set to be 0).

The justification of this process will be described below. An exemplary updated equation of q(zᵢⱼⁿ) in iterative optimization is given by:

$${q}^{t} ( {z}_{ij}^{n} ) ∝ {g}_{i}^{n} {g}_{j \vert i}^{n} p ( {x}^{n} \vert {φ}_{ij} ) exp \{ \frac{- {D}_{{β}_{i}}}{2 {\sum }_{n = 1}^{N} {\sum }_{j = 1}^{{K}_{2}} {q}^{t - 1} ( {z}_{ij}^{n} )} + \frac{- {D}_{{φ}_{ij}}}{2 {\sum }_{n = 1}^{N} {q}^{t - 1} ( {z}_{ij}^{n} )} \} \qquad ( Eqn . 6 )$$

In Eqn. 6, the exponential part includes a negative term and q(zᵢⱼⁿ) computed in the preceding process serves as the denominator of the term. Therefore, the smaller the value of this denominator, the smaller the value of optimized q(zᵢⱼⁿ), so that the variational probabilities of small path latent variables gradually reduce upon iterative computation.

The hierarchical latent structure optimization unit 201 (more specifically, the path latent variable summation operation unit 201-1, the path removal determination unit 201-2, and the path removal execution unit 201-3) is implemented by using the CPU of a computer operating in accordance with a program (hierarchical latent variable model estimation program).

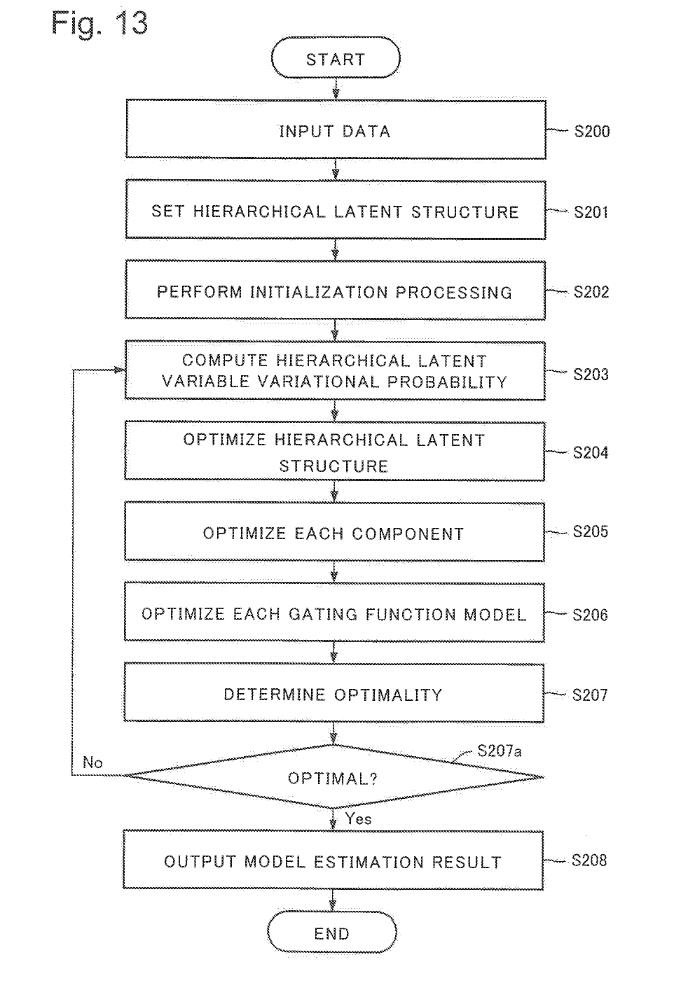

An exemplary operation of the hierarchical latent variable model estimation device 200 according to this exemplary embodiment will be described below. FIG. 13 is a flowchart illustrating an exemplary operation of the hierarchical latent variable model estimation device 200 according to at least one exemplary embodiment of the present invention.

A data input device 101 receives input data 111 first (step S200). A hierarchical latent structure setting unit 102 sets the initial state of the number of hidden states as a hierarchical latent structure (step S201).

In the first exemplary embodiment, an optimal solution is searched by executing all of a plurality of candidates for the number of components. In the second exemplary embodiment, the hierarchical latent structure can be optimized by only one process because the number of components is also optimized. Thus, in step S201, the initial value of the number of hidden states need only be set once instead of selecting a candidate remaining to be optimized from a plurality of candidates, as in step S102 of the first exemplary embodiment.

An initialization unit 103 initializes the latent variable variational probability and the parameter used for estimation, for the set hierarchical latent structure (step S202).

The hierarchical latent variable variational probability computation unit 104 computes each path latent variable variational probability (step S203). The hierarchical latent structure optimization unit 201 estimates the number of components to optimize the hierarchical latent structure (step S204). In other words, because the components are assigned to the respective nodes at the lowest level, when the hierarchical latent structure is optimized, the number of components is also optimized.

A component optimization unit 105 estimates the type of observation probability and the parameter for each component to optimize the components (step S205). A gating function model optimization unit 106 optimizes the branch parameter of each branch node (step S206). An optimality determination unit 107 determines whether the optimization criterion A has converged (step S207). In other words, the optimality determination unit 107 determines the model optimality.

If it is determined in step S207 that the optimization criterion A has not converged, that is, the model is not optimal (NO in step S207a), the processes in steps S203 to S207 are repeated.

If it is determined in step S207 that the optimization criterion A has converted (that is, the model is optimal) (YES in step S207a), a model estimation result output device 109 outputs a model estimation result 112 and ends the process (step S208).

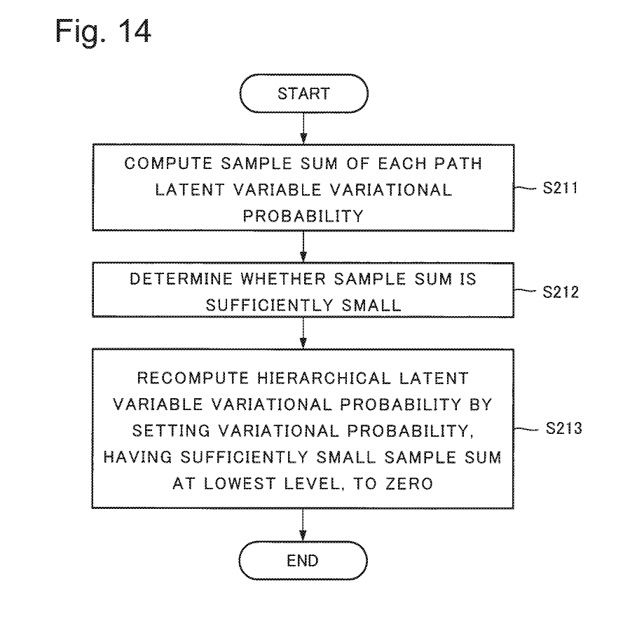

An exemplary operation of the hierarchical latent structure optimization unit 201 according to this exemplary embodiment will be described below. FIG. 14 is a flowchart illustrating an exemplary operation of the hierarchical latent structure optimization unit 201 according to at least one exemplary embodiment of the present invention.

The path latent variable summation operation unit 201-1 computes the sample sum of path latent variables first (step S211). The path removal determination unit 201-2 determines whether the computed sample sum is sufficiently small (step S212). The path removal execution unit 201-3 outputs a hierarchical latent variable variational probability recomputed after the lowest-level path latent variable variational probability determined to yield a sufficiently small sample sum is set to zero, and ends the process (step S213).

As descried above, in this exemplary embodiment, the hierarchical latent structure optimization unit 201 optimizes the hierarchical latent structure by removing a path having a computed variational probability equal to or lower than a predetermined threshold from the model.

With such a configuration, in addition to the effects of the first exemplary embodiment, a plurality of candidates for the hierarchical latent structure need not be optimized, as in the hierarchical latent variable model estimation device 100, and the number of components can be optimized as well by only one execution process. Therefore, the computation costs can be kept low by estimating the number of components, the type of observation probability, the parameters, and the variational distribution at once.

### Third Exemplary Embodiment

A third exemplary embodiment of a price prediction system will be described next. The price prediction system according to this exemplary embodiment is different from that according to the second exemplary embodiment in terms of the configuration of the hierarchical latent variable model estimation device. The hierarchical latent variable model estimation device according to this exemplary embodiment is different from the hierarchical latent variable model estimation device 200 in that in the former, the gating function model optimization unit 106 is replaced with an optimization unit 113 of a gating function model (a gating function model optimization unit 113).

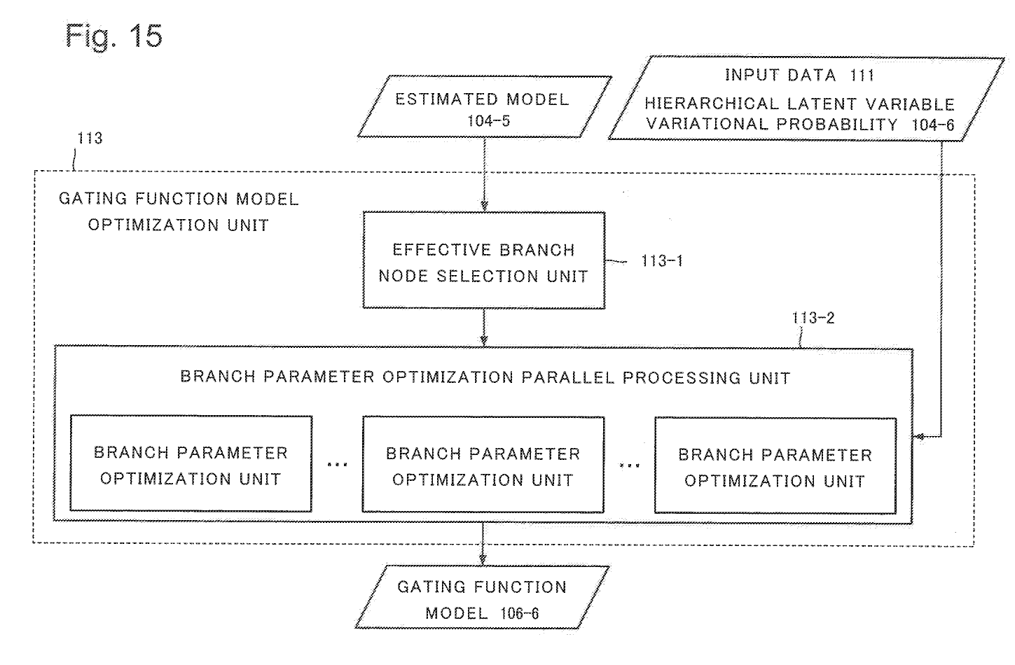

FIG. 15 is a block diagram illustrating an exemplary configuration of the gating function model optimization unit 113 according to the at least one exemplary embodiment of the present invention. The gating function model optimization unit 113 includes a selection unit 113-1 of an effective branch node (an effective branch node selection unit 113-1) and a parallel processing unit 113-2 of optimization of a branch parameter (a branch parameter optimization parallel processing unit 113-2).

The effective branch node selection unit 113-1 selects an effective branch node from the hierarchical latent structure. More specifically, the effective branch node selection unit 113-1 selects an effective branch node in consideration of paths removed from the model through the use of an model 104-5 estimated by a component optimization unit 105. The effective branch node indicates herein a branch node on a path not removed from the hierarchical latent structure.

The branch parameter optimization parallel processing unit 113-2 performs processes for optimizing the branch parameters for effective branch nodes in parallel and outputs the result of the processes as a gating function model 106-6. More specifically, the branch parameter optimization parallel processing unit 113-2 optimizes all branch parameters for all effective branch nodes, using input data 111 and a hierarchical latent variable variational probability 104-6 computed by a hierarchical latent variable variational probability computation unit 104.

The branch parameter optimization parallel processing unit 113-2 may be formed by, for example, arranging the branch parameter optimization units 106-3 according to the first exemplary embodiment in parallel, as illustrated in FIG. 15. Such a configuration allows optimization of the branch parameters for all gating function models at once.

In other words, the hierarchical latent variable model estimation devices 100 and 200 perform gating function model optimization processes one by one. The hierarchical latent variable model estimation device according to this exemplary embodiment enables more rapid estimation of model because it can perform gating function model optimization processes in parallel.

The gating function model optimization unit 113 (more specifically, the effective branch node selection unit 113-1 and the branch parameter optimization parallel processing unit 113-2) is implemented by using the CPU of a computer operating in accordance with a program (hierarchical latent variable model estimation program).

In each exemplary embodiment of the present invention, the process needs only to be substantially in parallel and, therefore, the process may be executed in simultaneously parallel or in pseud-parallel in accordance with computers executing the processes.

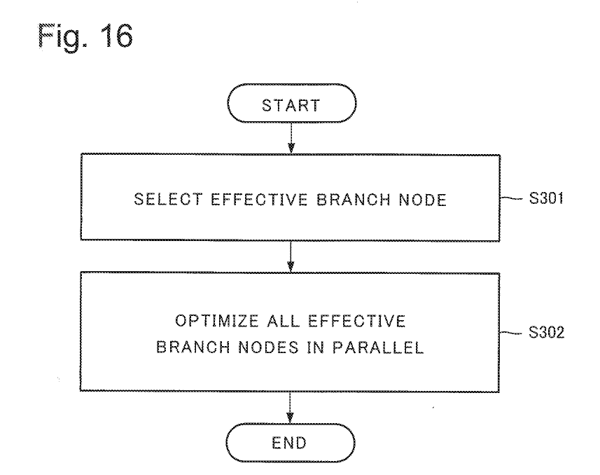

An exemplary operation of the gating function model optimization unit 113 according to this exemplary embodiment will be described below. FIG. 16 is a flowchart illustrating an exemplary operation of the gating function model optimization unit 113 according to at least one exemplary embodiment of the present invention. The effective branch node selection unit 113-1 selects all effective branch nodes first (step S301). The branch parameter optimization parallel processing unit 113-2 optimizes all the effective branch nodes in parallel and ends the process (step S302).

As described above, according to this exemplary embodiment, the effective branch node selection unit 113-1 selects an effective branch node from the nodes of the hierarchical latent structure. The branch parameter optimization parallel processing unit 113-2 optimizes the gating function model on the basis of the latent variable variational probability related to the effective branch node. In doing this, the branch parameter optimization parallel processing unit 113-2 processes optimization of each branch parameter of the effective branch node in parallel. This enables parallel processes for optimizing the gating function models and thus enables more rapid estimation of model in addition to the effects of the aforementioned exemplary embodiments.

[symbol] Basic Configuration

[symbol]

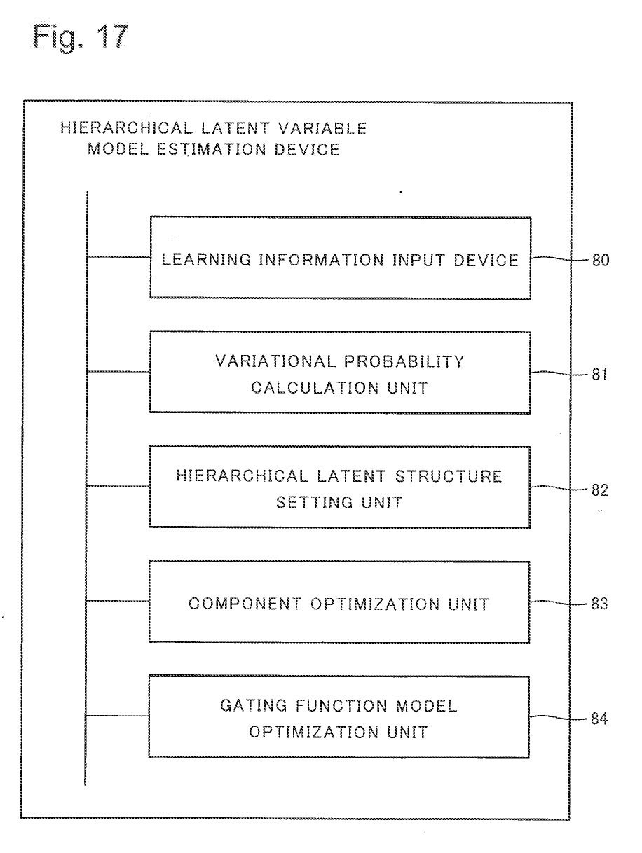

The basic configuration of a hierarchical latent variable model estimation device will be described below. FIG. 17 is a block diagram illustrating a basic configuration of a hierarchical latent variable model estimation device according to at least one exemplary embodiment of the present invention.

The hierarchical latent variable model estimation device estimates a hierarchical latent variable model for estimating a price of a target. The hierarchical latent variable model estimation device includes a learning information input unit 80, a variational probability calculation unit 81, a hierarchical latent structure setting unit 82 (a setting unit 82 of a hierarchical latent structure), a component optimization unit 83 (an optimization unit 83 of components) and a gating function model optimization unit 84 (an optimization unit 84 of gating function models).

The learning information input unit 80 input learning data that include a combination of a target variable of a known price and at least explanatory variable that is information expected to influence a price. Examples of the learning information input unit 80 may include the data input device 101.

The hierarchical latent structure setting unit 82 sets a hierarchical latent structure. In the hierarchical latent structure, latent variables are represented, for example, by a tree structure and components representing probability models are assigned to the nodes at the lowest level of the hierarchical structure. Examples of the hierarchical latent structure setting unit 82 may include the hierarchical latent structure setting unit 102.

The hierarchical latent variable variational probability computation unit 81 computes a variational probability (that is, the optimization criterion A) of path latent variables that are latent variables in a path from the root node to a target node. Examples of the hierarchical latent variable variational probability computation unit 81 may include the hierarchical latent variable variational probability computation unit 104.

The component optimization unit 83 optimizes the components for the calculated variational probability on the basis of the learning data inputted by the learning information input unit 80. Examples of the component optimization unit 83 may include the component optimization unit 105.

The gating function model optimization unit 84 optimizes the gating function models that determines a branch direction in accordance with the explanatory variable(s) at each node of the hierarchical latent structure on the basis of a latent variable variational probability at the node. Examples of the gating function model optimization unit 84 may include the gating function model optimization unit 106.

The hierarchical latent variable model estimation device including the above-mentioned configuration estimates a hierarchical latent variable model including hierarchical latent variables with an adequate amount of computation without losing theoretical justification.

The hierarchical latent variable model estimation device may include a hierarchical latent structure optimization unit (for example, the hierarchical latent structure optimization unit 201) that optimizes a hierarchical latent structure by deleting paths having a calculated variational probability that is equal or lower than a predetermined threshold. In other word, the hierarchical latent variable model estimation device may include a hierarchical latent structure optimization unit that optimizes a hierarchical latent structure by deleting paths having a calculated variational probability not satisfying a criterion. With such a configuration, a plurality of candidates for the hierarchical latent structure need not be optimized and the number of components can be optimized as well by only one execution process.

The gating function model optimization unit 84 may include an effective branch node selection unit (for example, the effective branch node selection unit 113-1) that selects effective branch nodes, that is a branch node on a path not removed from the hierarchical latent structure, from nodes in the hierarchical latent structure. The gating function model optimization unit 84 may include a branch parameter optimization parallel processing unit (for example, the branch parameter optimization parallel processing unit 113-2) that optimizes gating function models on the basis of a latent variable variational probability of the effective branch nodes. The branch parameter optimization parallel processing unit may process optimization of each branch parameter related to the effective branch nodes in parallel. Such a configuration enables more rapid estimation of model.

The hierarchical latent structure setting unit 82 may set a hierarchical latent structure having latent variables represented in a binary tree. The gating function model optimization unit 84 may optimize the gating function model based on the Bernoulli distribution on the basis of the latent variable variational probability at the node. This enables more rapid optimization because each parameter has an analytic solution.

More specifically, the hierarchical latent variable variational probability computation unit 81 may compute the latent variable variational probability so as to maximize the marginal log-likelihood.

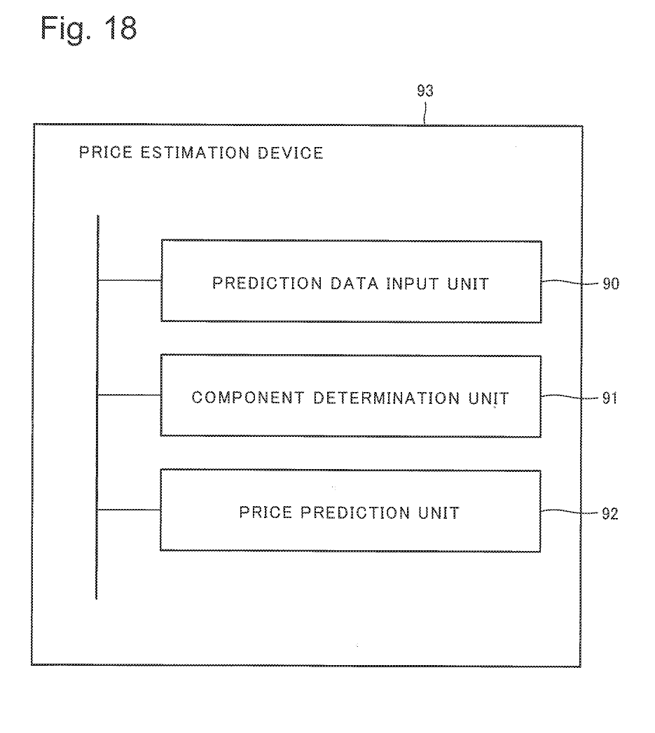

The basic configuration a price estimation device 93 will be described below. FIG. 18 is a block diagram illustrating a basic configuration of a price estimation device 93 according to at least one exemplary embodiment of the present invention.

A price prediction device 93 includes a prediction data input unit 90, a component determination unit 91, and a price prediction unit 93.

The prediction-data input unit 90 receives prediction data representing at least one explanatory variable that is information expected to influence the price of a product. Examples of the prediction-data input unit 90 may include a data input device 701.

The component determination unit 91 determines components used to predict the price on the basis of a hierarchical latent structure where latent variables are represented by a hierarchical structure, gating function models for selecting the branch direction at the node of the hierarchical latent structure, and the prediction data. Examples of the component determination unit 91 may include a component determination unit 703.

On the basis of the prediction data and the component selected by the component determination unit 91, the price prediction unit 92 evaluates a price of a product. Examples of the price prediction unit 92 may include a price prediction unit 704.

With such a configuration, the price determination device can determine an appropriate price on the basis of an appropriate component selected in accordance with the gating function model.

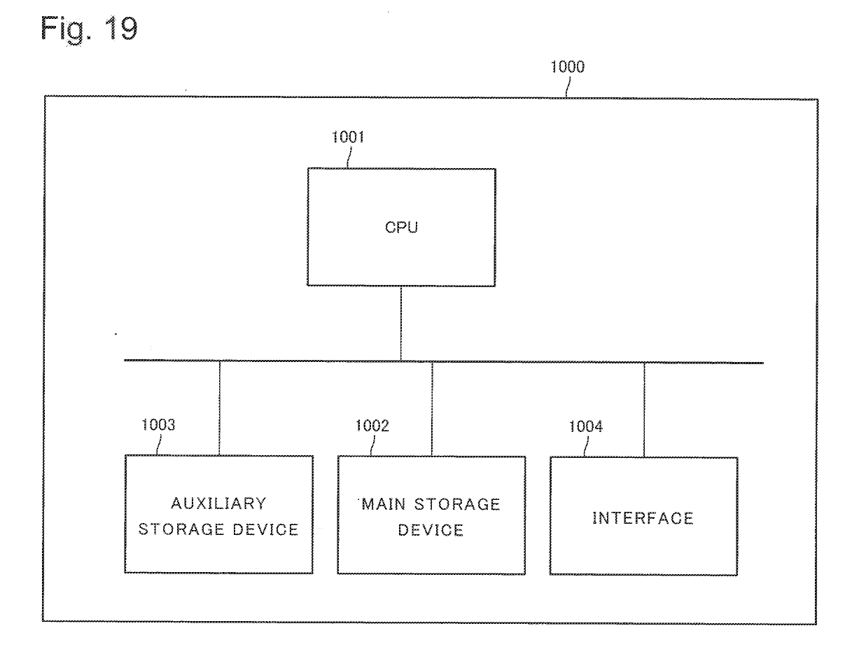

FIG. 19 is a block diagram illustrating the configuration of a computer according to at least one exemplary embodiment of the present invention.

A computer 1000 includes a CPU 1001, a main storage device 1002, an auxiliary storage device 1003, and an interface 1004.

Each of the above-mentioned hierarchical latent variable model estimation devices and price prediction devices are implemented in the computer 1000. The computer 1000 equipped with the hierarchical latent variable model estimation device may be different from the computer 1000 equipped with the price prediction device. The operation of each of the above-mentioned processing units is stored in the auxiliary storage device 1003 in the form of a program (a hierarchical latent variable model estimation program or a price prediction program). The CPU 1001 reads the program from the auxiliary storage device 1003 and expands it into the main storage device 1002 to execute the above-mentioned processes in accordance with this program.

In at least one exemplary embodiment, the auxiliary storage device 1003 exemplifies a non-transitory tangible medium. Other examples of the non-transitory tangible medium may include a magnetic disk, a magneto-optical disk, a CD (Compact Disc)-ROM (Read Only Memory), a DVD (Digital Versatile Disk)-ROM, and a semiconductor memory connected via the interface 1004. When the program is distributed to the computer 1000 via a communication line, the computer 1000 may, in response to the distribution, store this program into the main storage device 1002 and execute the above-mentioned process.

The program may implement some of the above-mentioned functions. Further, the program may serve as one which implements the above-mentioned functions in combination with other programs already stored in the auxiliary storage device 1003, that is, a so-called difference file (difference program).

### Fourth Exemplary Embodiment

A fourth exemplary embodiment will be described next.

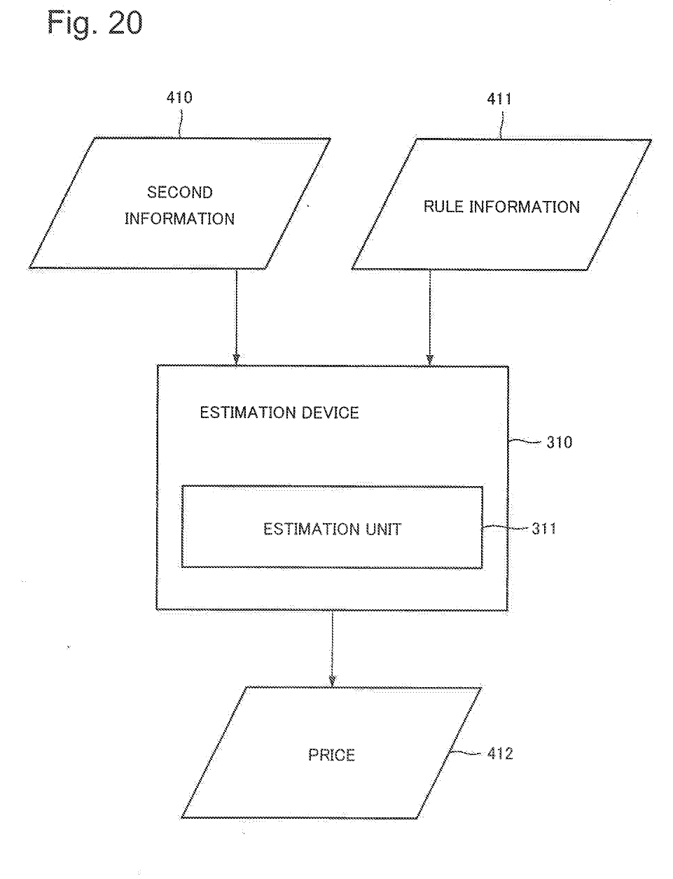

With reference to FIG. 20, a configuration of an estimation device 310 according to the fourth exemplary embodiment, and processing performed by the estimation device 310 will be described. FIG. 20 is a block diagram illustrating a configuration of the estimation device 310 according to the fourth exemplary embodiment of the present invention.

The estimation device 310 according to the fourth exemplary embodiment includes an estimation unit 311.

When estimating a price of a target object in a second time, the estimation unit 311 first receives second information 410 including one or more explanatory variables.

The second information 410 will be described.

At least one of the explanatory variables is a feature representing a length of a period between a first time and the second time. The first time and the second time represent timings when a specific event occurs with respect to the target object. The specific event is an event occurring with respect to the target object. For example, when the target object is a device, a specific event is an event such as purchasing the device, maintaining the device, and start selling a device assigned with the same model number as the device. The specific event may be an event such as start selling an upgraded version of the device while being assigned with a different model number from the device.

When the target object is a vehicle, the second time represents, for example, a time planned for disposal of the vehicle.

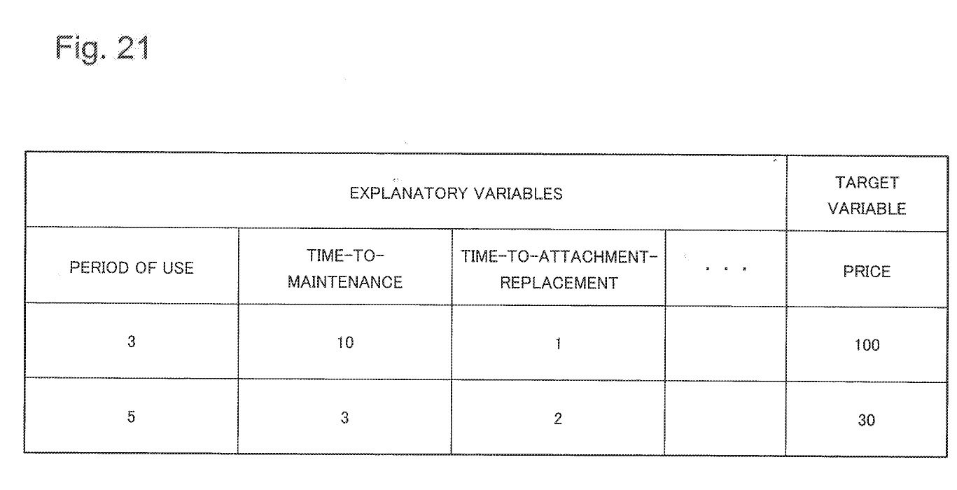

Furthermore, the estimation unit 311 receives rule information 411 representing a rule computed on the basis of a first information set as exemplified in FIG. 21. FIG. 21 is a diagram conceptually illustrating an example of the first information set according to at least one of the exemplary embodiments of the present invention.

The first information set includes a plurality of pieces of first information. Values of one or more explanatory variables are associated with a value of a target variable (price) in the first information. In other words, a target object (referred to as “second target object” for convenience of description) is associated with a price related to the second target object in the first information.

At least one of the explanatory variables is a feature representing a length of a period between the first time related to the target object represented by the first information and a third time associated with the target variable. In the example illustrated in FIG. 21, the feature represents a period of use, a time-to-maintenance, or a time-to-attachment-replacement. The feature is not limited to the example illustrated in FIG. 21.

For example, the second row in FIG. 21 indicates an example of the first information. Specifically, 3 (a value representing a period of use), 10 (a value representing a time-to-maintenance), and 1 (a value representing a time-to-attachment-replacement) are associated with 100 (a value representing a price) in the first information.

The aforementioned third time represents, for example, a time when a vehicle is disposed.

Further, in the example illustrated in FIG. 21, a period of use represents a period between a time when the vehicle is purchased and a time when the vehicle is disposed. In this case, a specific event represents an event of purchasing the vehicle.

Further, in the example illustrated in FIG. 21, a time-to-maintenance represents a period between a time when the vehicle is disposed and a time when next maintenance is required for the vehicle. In this case, a specific event represents an event of maintaining the vehicle. For example, a time-to-maintenance represents a remaining period of legal vehicle inspection with respect to the vehicle.

Additionally, in the example illustrated in FIG. 21, a time-to-attachment-replacement represents a period between a time when the vehicle is disposed and a time when next replacement is required with respect to an attachment attached to the vehicle. In this case, a specific event represents an event of next replacement related to an attachment attached to the vehicle. For example, the attachment is a wheel attached on vehicle.

Next, the rule information 411 will be described. For example, a technique such as a support vector machine, a neural network, or a decision tree may compute a rule. Alternatively, the hierarchical latent variable model estimation device according to the first to third exemplary embodiments of the present invention may compute rule information (such as a component and a gating function model).

The estimation unit 311 first applies the rule information 411 to the second information 410 and computes the result as a price 412.

Next, an effect that can be provided by the estimation device 310 according to the fourth exemplary embodiment will be described.

The estimation device 310 according to the present exemplary embodiment is able to predict a price at a second time related to a target object accurately.

The reason is that a price at a second time related to a target object often varies depending on a specific event related to the target object.

For example, when a target object is a vehicle, a disposal price often relates to a remaining period of vehicle inspection at the time of disposal. In this case, there is relevance between the remaining period and the disposal price. The estimation device 310 predicts a price being a prediction target on the basis of rule information 411 representing the relevance. A price predicted by the estimation device 310 is based on relevance between the remaining period and the disposal price and therefore is a more accurate.

Further, when a target object is a facility, a disposal price of the facility is influenced by a time-to-replacement of an attachment constituting the facility, an elapsed time from purchase of the facility, and the like. In this case, the price predicted by the estimation device 310 is based on relevance among the time-to-replacement, the elapsed time, and the disposal price, and therefore is a more accurate price.

Therefore, the estimation device 310 according to the present exemplary embodiment is able to predict a price at a second time related to a target object, with a high degree of precision.

### Fifth Exemplary Embodiment

Next, a fifth exemplary embodiment of the present invention based on the aforementioned exemplary embodiments will be described.

In the following description, a part characteristic of the present exemplary embodiment is mainly described, and a same reference numeral is given to a similar configuration described in the aforementioned exemplary embodiments, thus omitting a redundant description thereof.

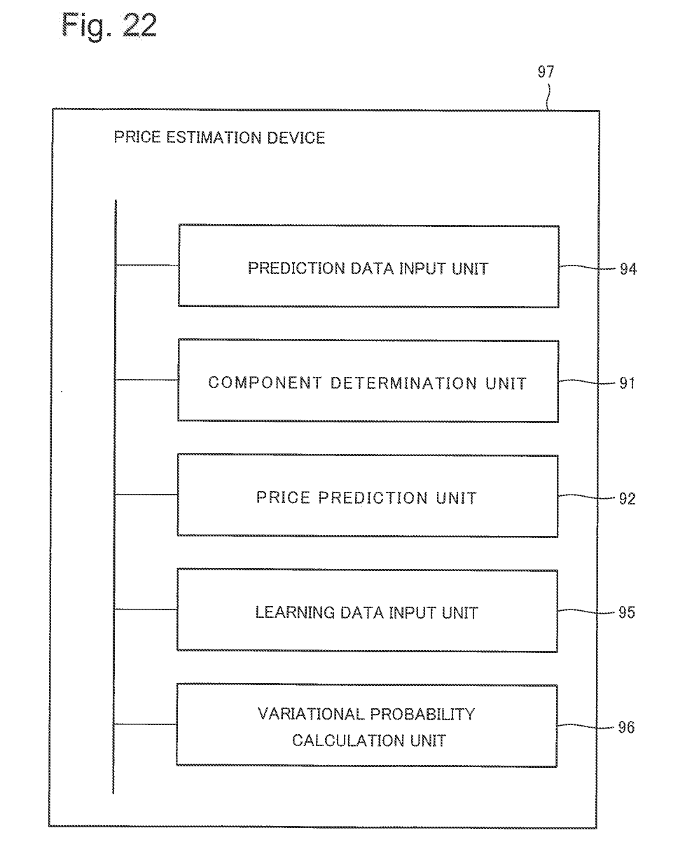

With reference to FIG. 22, a configuration of a price estimation device 97 according to the fifth exemplary embodiment, and processing performed by the price estimation device 97 will be described. FIG. 22 is a block diagram illustrating a configuration of the price estimation device 97 according to the fifth exemplary embodiment of the present invention.

The price estimation device 97 according to the fifth exemplary embodiment includes a prediction data input unit 94, a component determination unit 91, and a price prediction unit 92. The price estimation device 97 may further include a learning data input unit 95 and a variational probability calculation unit 96.

The prediction data input unit 94 first inputs second information being one or more explanatory variables being information potentially influencing a price. At least one of the explanatory variables is the feature described in the fourth exemplary embodiment of the present invention. Further, the data input device 701 may be given as an example of the prediction data input unit 94.

The component determination unit 91 determines a component on the basis of second information in the prediction data input unit 94.

Next, the price prediction unit 92 predicts a price on the basis of the component determined by the component determination unit 91, and the like.

At least one of the explanatory variables is the feature described in the fourth exemplary embodiment of the present invention. Therefore, the price estimation device 97 according to the fifth exemplary embodiment is able to predict a price with a high degree of precision on the basis of a similar reason to the reason described in the fourth exemplary embodiment.

Additionally, a case that the price estimation device 97 further includes the learning data input unit 95 and the variational probability calculation unit 96 will be described in addition to the aforementioned configuration.

The learning data input unit 95 inputs a target variable being a price, and first information being a plurality of combinations of one or more explanatory variables being information potentially influencing the price. The data input device 101 may be given as an example of the learning data input unit 95.

The variational probability calculation unit 96 computes a variational probability (such as the optimization criterion A) of a path latent variable being a latent variable included in a path connecting a root node and a target node in a hierarchical latent structure on the basis of learning information 2301 input by the learning data input unit 95 and a component. At this time, the variational probability calculation unit 81 allocates the aforementioned feature to a node on the path. The hierarchical latent variable variational probability computation unit 104 may be given as an example of the variational probability calculation unit 96.

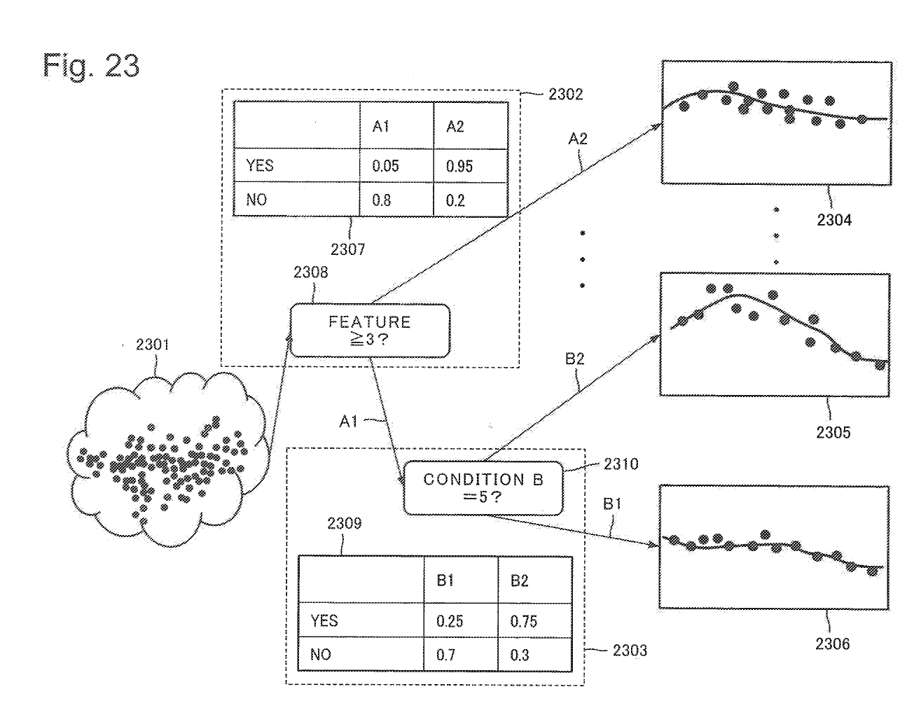

With reference to FIG. 23, an example of a gating function model and a component being computed on the basis of the learning information 2301 will be described. FIG. 23 is a diagram illustrating an example of a gating function model and a component, being computed by the price estimation device 97, when the latent variable model according to at least one of the exemplary embodiments of the present invention has a tree structure.

A condition related to a specific explanatory variable (a random variable in this case) is assigned to each nodal point (nodes 2302 and 2303) in the tree structure. In other words, the variational probability calculation unit 96 arranges the aforementioned feature in an explanatory variable.

For example, the node 2302 represents a condition related to whether or not a value of the feature is greater than or equal to 3 (condition information 2308). Similarly, the node 2303 represents a condition related to whether or not a value of an explanatory variable B is 5 (condition information 2310). In other words, in this example, the variational probability calculation unit 96 arranges the aforementioned feature in the node 2302.

A probability (probability information 2307 and 2309) related to selection of next branch node or next component based on a value of an explanatory variable is allocated to the explanatory variable.

For example, it is assumed that, at the node 2302, when a value of the explanatory variable A is greater than or equal to 3 (that is, YES in the condition information 2308), the probability of selecting a branch A1 is 0.05 and the probability of selecting a branch A2 is 0.95 on the basis of the probability information 2307. It is further assumed that, when a value of the explanatory variable A is less than 3 (that is, NO in the condition information 2308), the probability of selecting the branch A1 is 0.8 and the probability of selecting the branch A2 is 0.2 on the basis of the probability information 2307.

Similarly, for example, it is assumed that, at the node 2303, when a value of the explanatory variable B is equal to 5 (that is, YES in the condition information 2310), the probability of selecting a branch B1 is 0.25 and the probability of selecting a branch B2 is 0.75 on the basis of the probability information 2309. It is further assumed that, when a value of the explanatory variable B is not equal to 5 (that is, NO in the condition information 2310), the probability of selecting the branch B1 is 0.7 and the probability of selecting the branch B2 is 0.3 on the basis of the probability information 2309.

For convenience of description, it is assumed that the value of the explanatory variable A is 4, and the value of the explanatory variable B is 7.

In this case, the value of the explanatory variable A is greater than or equal to 3, and therefore the probability of selecting the branch A1 is 0.05 and the probability of selecting the branch A2 is 0.95. The value of the explanatory variable B is not equal to 5, and therefore the probability of selecting the branch B1 is 0.7 and the probability of selecting the branch B2 is 0.3. In other words, the probability of a model being a component 2306 is 0.05×0.7=0.035 as the component 2306 is reachable via the branches A1 and B1. The probability of the model being a component 2305 is 0.05×0.3=0.015 as the component 2305 is reachable via the branches A1 and B2. The probability of the model being a component 2304 is 0.95 as the component 2304 is reachable via the branch A2. Thus, the probability of the model being the component 2304 is maximum, and therefore a price estimation unit 92 predicts a price related to a target object in accordance with the component 2304.

While a case that a latent variable model has a tree structure has been described in the aforementioned example, even in a case that a latent variable model has a hierarchical structure, a probability related to a component is computed by use of a gating function model, and a component having the maximum probability is selected.

Next, an effect that can be provided by the price estimation device 97 according to the fifth exemplary embodiment will be described.

The price estimation device 97 according to the present exemplary embodiment is able to predict a price more precisely.

The reason is that the aforementioned feature is used as one of the explanatory variables. An additional reason is that price estimation device 97 includes a configuration of the hierarchical latent variable model estimation device according to the respective aforementioned exemplary embodiments of the present invention.

### Sixth Exemplary Embodiment

Next, a sixth exemplary embodiment of the present invention based on the aforementioned exemplary embodiments will be described.

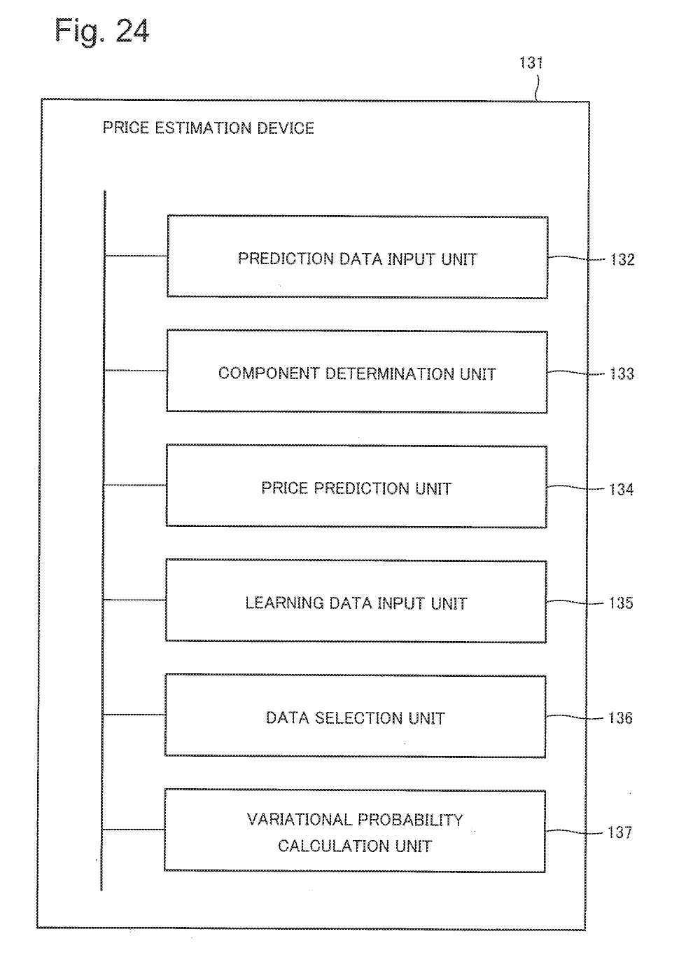

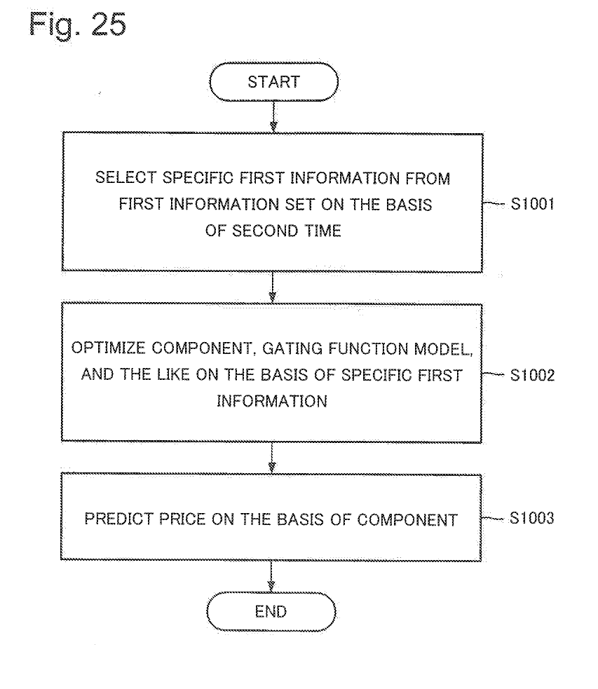

With reference to FIGS. 24 and 25, a configuration of a price estimation device 131 according to the sixth exemplary embodiment, and processing performed by the price estimation device 131 will be described. FIG. 24 is a block diagram illustrating a configuration of the price estimation device 131 according to the sixth exemplary embodiment of the present invention. FIG. 25 is a flowchart illustrating a processing flow in the price estimation device 131 according to the sixth exemplary embodiment.

The price estimation device 131 according to the sixth exemplary embodiment includes a prediction data input unit 132, a component determination unit 133, and a price prediction unit 134. The price estimation device 131 further includes a learning data input unit 135, a data selection unit 136, and a variational probability calculation unit 137.

The learning data input unit 135 inputs a target variable representing a price, and a first information set composed of first information being a plurality of combinations of one or more explanatory variables being information potentially influencing the price. The data input device 101 may be given as an example of the learning data input unit 135. Each piece of first information is associated with a first time when a target variable (price) related to a target object associated with the first information is determined.

The prediction data input unit 132 inputs second information being one or more explanatory variables being information potentially influencing a price. The data input device 701 may be given as an example of the prediction data input unit 132. The second information is associated with a second time when a price is predicted with respect to a target object associated with the second information.

The data selection unit 136 selects specific first information out of the first information set on the basis of the second time (Step S1001).

For example, the data selection unit 136 selects specific first information with a period between the second time and a first time associated with the first information being less than or equal to a specific value out of the first information set. Alternatively, the data selection unit 136 may select specific first information being earlier than the second time and having a period between the first time and the second time being less than or equal to a specific value. Alternatively, the data selection unit 136 may select a specific number of pieces of first information in ascending order of period between the first time and the second time. The processing in the data selection unit 136 is not limited to the aforementioned example.

Next, the variational probability calculation unit 137 computes a variational probability on the basis of the specific first information selected by the data selection unit 136 (Step S1002). The hierarchical latent variable variational probability computation unit 104 may be given as an example of the variational probability calculation unit 137.

Next, the component determination unit 133 determines a component on the basis of the second information. In this case, the component determination unit 133 determines a component in accordance with a hierarchical latent structure being a structure in which a latent variable is expressed by a hierarchical structure and a component representing a probability model is arranged in a node at the lowest level of the hierarchical structure, and a gating function model determining a branching direction in a node in the hierarchical latent structure. The component determination unit 703 may be given as an example of the component determination unit 133.

Next, the price prediction unit 134 predicts a price at the second time related to the second information on the basis of the component selected by the component determination unit 133 (Step S1003). The price prediction unit 704 may be given as an example of the price prediction unit 134.

Next, an effect that can be provided by the price estimation device 131 according to the sixth exemplary embodiment will be described.

The price estimation device 131 according to the present exemplary embodiment is able to predict a price with a yet higher degree of precision.

The reasons are, for example, a reason 1 and a reason 2. That is:

(Reason 1) A configuration of the price estimation device according to the sixth exemplary embodiment includes a configuration of the price estimation device according to the aforementioned exemplary embodiments; and

(Reason 2) Second information is similar to (or matches) first information, and therefore a component, a gating function model, and the like suitable for classifying the second information can be generated.

As described above, the data selection unit 136 selects first information associated with a first time close to a second time. For example, when a target object is a specific type of a vehicle, prices of the vehicle tend to be more similar (or match), as disposal times become closer. Accordingly, first information and second information become similar to (or match) one another by the data selection unit 136 performing the aforementioned processing.

### Seventh Exemplary Embodiment

Next a seventh exemplary embodiment of the present invention based on the aforementioned exemplary embodiments will be described.

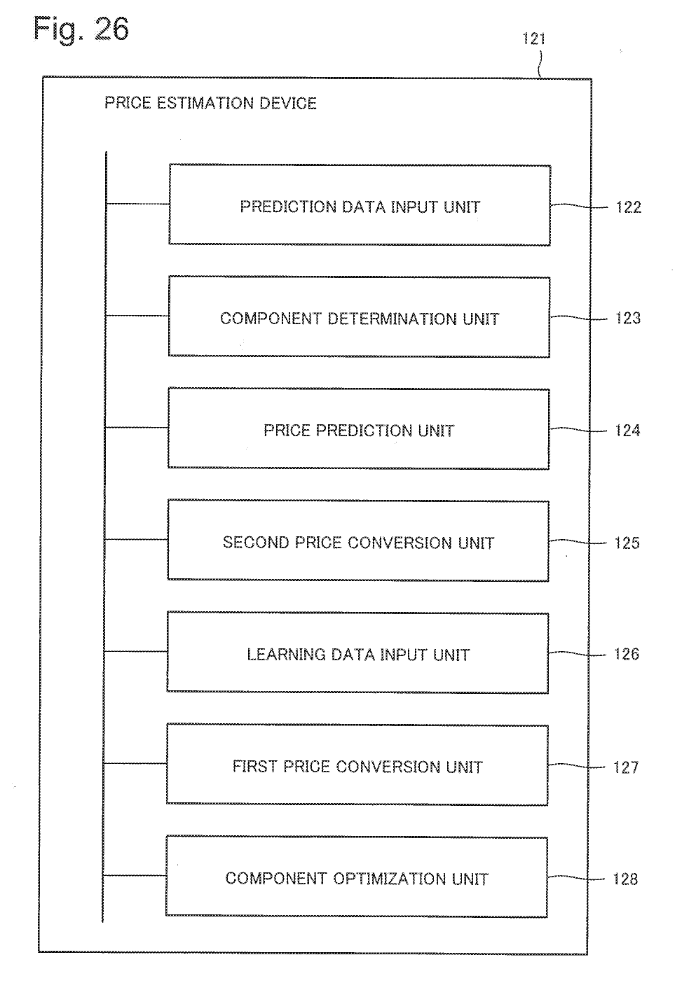

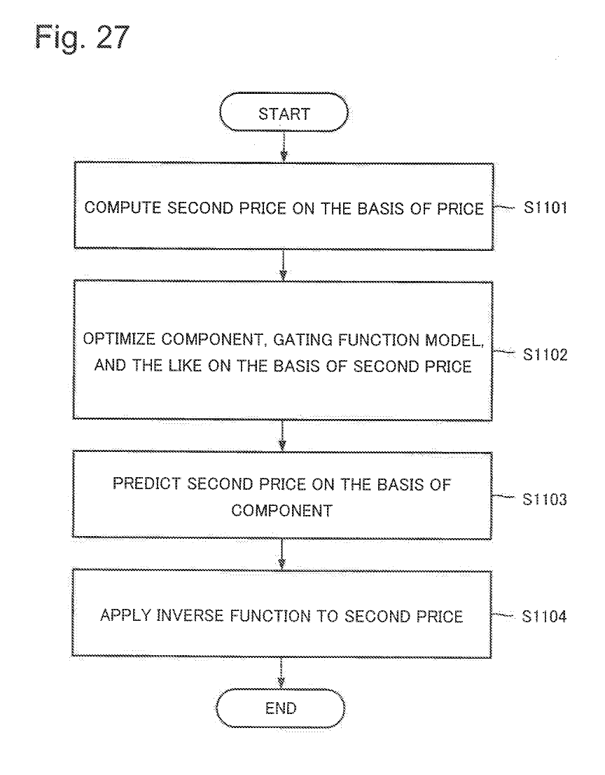

With reference to FIGS. 26 and 27, a configuration of a price estimation device 121 according to the seventh exemplary embodiment, and processing performed by the price estimation device 121 will be described. FIG. 26 is a block diagram illustrating a configuration of the price estimation device 121 according to the seventh exemplary embodiment of the present invention. FIG. 27 is a flowchart illustrating a processing flow in the price estimation device 121 according to the seventh exemplary embodiment.

The price estimation device 121 according to the seventh exemplary embodiment includes a prediction data input unit 122, a component determination unit 123, a price prediction unit 124, and a second price conversion unit 125. The price estimation device 121 further includes a learning data input unit 126, a first price conversion unit 127, and a component optimization unit 128.

The learning data input unit 126 inputs a target variable being a price and a first information set including first information being a plurality of combinations of one or more explanatory variables being information potentially influencing the price. The data input device 101 may be given as an example of the learning data input unit 126.

Next, the first price conversion unit 127 computes a second price by applying a specific conversion function to a target variable (price) in the first information set input by the learning data input unit 126 (Step S1101). Then, the first price conversion unit 127 generates third information, by associating the computed second price with explanatory variables which are associated with a price being a basis of the computation of the second price. Specifically, the first price conversion unit 127 computes a third information set including the third information on the basis of the first information set.

For example, the specific conversion function is a monotonic predetermined function with varying inclinations, such as an exponential function and a logarithmic function.

Next, the component optimization unit 128 optimizes a component with respect to a computed variational probability on the basis of the third information set (Step S1102). The component optimization unit 105 may be given as an example of the component optimization unit 128.

Further, the prediction data input unit 122 inputs second information being one or more explanatory variables being information potentially influencing a price. The data input device 701 may be given as an example of the prediction data input unit 122.

Next, the component determination unit 123 determines a component used for prediction of a price on the basis of a hierarchical latent structure being a structure in which a latent variable is expressed by a hierarchical structure and a component representing a probability model is arranged in a node at the lowest level of the hierarchical structure, a gating function model determining a branching direction in a node in the hierarchical latent structure, and the second information. In this case, the component is a component optimized by the component optimization unit 128 on the basis of the third information set. The component determination unit 703 may be given as an example of the component determination unit 123.

Next, the price prediction unit 124 predicts a second price on the basis of the component determined by the component determination unit 123 and on the basis of the second information (Step S1103). The price prediction unit 704 may be given as an example of the price prediction unit 124.

Next, the second price conversion unit 125 computes a price by setting an inverse function of the specific conversion function applied by the first price conversion unit 127 to the second price predicted by the price prediction unit 124 (Step S1104).

Next, an effect that can be provided by the price estimation device 121 according to the seventh exemplary embodiment will be described.

The price estimation device 121 according to the present exemplary embodiment is able to predict a specific price range more precisely in addition to the aforementioned effects.

The reasons are, for example, a reason 1 and a reason 2. That is:

(Reason 1) A configuration of the price estimation device 121 according to the seventh exemplary embodiment includes a configuration of the price estimation device according to the aforementioned exemplary embodiments; and

(Reason 2) A difference in price in a specific price range is extended by the first price conversion unit 127 and the second price conversion unit 125 using a specific conversion function.

For example, when the specific conversion function is a logarithmic function, a difference between two pieces of data is extended in a low price range where a price is close to zero. On the other hand, a difference between two pieces of data in a high price range becomes smaller. Accordingly, in this case, the price estimation device 121 is able to precisely predict a low price range. Furthermore, when the specific conversion function is a logarithmic function, a value of the inverse function of the specific conversion function is always a positive value. In this case, a price predicted by the price estimation device 121 is always positive, and therefore the price estimation device 121 also provides an effect that a more reasonable price is computed.

For example, when the specific conversion function is an exponential function, a difference between two pieces of data in a high price range is extended. On the other hand, a difference between two pieces of data in a low price range becomes smaller. Accordingly, in this case, the price estimation device 121 is able to precisely predict a high price range.

The present invention has been described above by taking the above-described exemplary embodiments as exemplary examples. However, the present invention is not limited to the above-described exemplary embodiments. In other words, the present invention can adopt various modes which would be understood by those skilled in the art without departing from the scope of the present invention.

This application claims priority based on U.S. Patent 61/971,594 filed on Mar. 28, 2014, the disclosure of which is incorporated herein by reference in its entirety.

### REFERENCE SIGNS LIST

10: price prediction system
100: hierarchical latent variable model estimation device
300: learning database
500: model database
700: price prediction device
111: input data
101: data input device
102: hierarchical latent structure setting unit
103: initialization unit
104: hierarchical latent variable variational probability computation unit
105: component optimization unit
106: gating function model optimization unit
107: optimality determination unit
108: optimal model selection unit
109: model estimation result output device
112: model estimation result
104-1: lowest-level path latent variable variational probability computation unit
104-2: hierarchical setting unit
104-3: higher-level path latent variable variational probability computation unit
104-4: hierarchical computation end determination unit
104-5: estimated model
104-6: hierarchical latent variable variational probability
701: data input device
702: model acquisition unit
703: component determination unit
704: price prediction unit
705: prediction result output device
711: input data
712: prediction result
200: hierarchical latent variable model estimation device
201: hierarchical latent structure optimization unit
201-1: path latent variable summation operation unit
201-2: path removal determination unit
201-3: path removal execution unit
113: gating function optimization unit
113-1: effective branch node selection unit
113-2: branch parameter optimization parallel processing unit
106-1: branch node information acquisition unit
106-2: branch node selection unit
106-3: branch parameter optimization unit
106-4: total branch node optimization end determination unit
106-6: gating function model
80: learning information input device
81: variational probability calculation unit
82: hierarchical latent structure setting unit
83: component optimization unit
84: gating function model optimization unit
90: prediction-data input unit
91: component determination unit
92: shipment-volume prediction unit
93: order-volume determination unit
1000: computer
1001: CPU
1002: main storage device
1003: auxiliary storage device
1004: interface
310 Estimation device
311 Estimation unit
410 Second information
411 Rule information
412 Price
94 Prediction data input unit
95 Learning data input unit
96 Variational probability calculation unit
97 Price estimation device
2301 Learning information
2302 Node
2303 Node
2304 Component
2305 Component
2306 Component
2307 Probability information
2308 Condition information
2309 Probability information
2310 Condition information
131 Price estimation device
132 Prediction data input unit
133 Component determination unit
134 Price prediction unit
135 Learning data input unit
136 Data selection unit
137 Variational probability calculation unit
121 Price estimation device
122 Prediction data input unit
123 Component determination unit
124 Price prediction unit
125 Second price conversion unit
126 Learning data input unit
127 First price conversion unit
128 Component optimization unit

What is claimed is:

1. A hierarchical price estimation device comprising:
a prediction data input unit configured to input prediction data being one or more explanatory variables potentially influencing a price;
a component determination unit configured to determine a component used for prediction of the price on the basis of:
a hierarchical latent structure in which a latent variable is expressed by a hierarchical structure which includes (i) one or more nodes arranged at each level of the hierarchical structure, (ii) a path between a node arranged at a first level and a node arranged at a subordinate second level, and (iii) the component representing a probability model is arranged in a node at a lowest level of the hierarchical structure,
a gating function model being a basis of determining the path between nodes constituting the hierarchical latent structure, when determining the component, and
the prediction data; and
a price prediction unit configured to predict the price on the basis of the component determined by the component determination unit and the prediction data.

2. The price estimation device according to claim 1, further comprising:
an optimization unit configured to optimize the hierarchical latent structure, by excluding the path with a variational probability, which represents a probability distribution of the latent variable, not meeting a criterion, from a processing target on which optimization processing is performed in the hierarchical latent structure.

3. The price estimation device according to claim 2, further comprising:
an optimization unit includes:
a selection unit configured to select an effective branch node, that represents a branch node not excluded from the hierarchical latent structure, in the path, out of nodes in the hierarchical latent structure, and
a parallel processing unit configured to optimize the gating function model on the basis of the variational probability of the latent variable in the effective branch node, wherein
the parallel processing unit performs parallel optimization processing on each branch parameter related to the effective branch node.

4. The price estimation device according to claim 1, further comprising:
a setting unit configured to set the hierarchical latent structure in which the latent variable is expressed by use of a binary tree structure; and
an optimization unit configured to optimize the gating function model based on a Bernoulli distribution on the basis of a variational probability representing a probability distribution of the latent variable in each node.

5. The price estimation device according to claim 1, further comprising:
a variational probability computation unit configured to compute a variational probability representing a probability distribution of the latent variable so as to maximize a marginal log likelihood.

6. A price estimation device comprising:
a price prediction unit configured to predict a price, being a prediction target, related to second information at a second time by applying rule information representing a relation, that is computed based on a first information set including first information associating a value of explanatory variables with a value of the price, between the explanatory variables and the price to the second information including the explanatory variables, wherein
the explanatory variables includes a feature representing a period determined on the basis of a first time when a specific event occurs with respect to a target object associated with the first information or the second information,
a value of the feature in the second information is a period between the first time and the second time, and
a value of the feature in the first information is a period between the first time and a third time associated with the price.

7. The price estimation device according to claim 6, wherein,
when estimating a price at the second time related to a target object represented by the second information, at least one of the explanatory variable is a feature representing a period between a first time when a specific event occurs with respect to the target object, and the second time.

8. The price estimation device according to claim 7, further comprising:
a variational probability computation unit configured to arrange the feature in a path in a hierarchical latent structure in which a latent variable is expressed by a hierarchical structure and in which components representing a probability model are arranged in a node at a lowest level of the hierarchical structure, and, subsequently compute a variational probability of a latent variable so as to maximize a marginal log likelihood.

9. The price estimation device according to claim 8, further comprising:
a data selection unit configured to select specific first information out of a first information set including first information associated with the explanatory variables and a price, when a prediction target is the price related to a specific time, on the basis of the specific time, wherein
the variational probability computation unit computes the variational probability on the basis of the specific first information.

10. The price estimation device according to claim 7, further comprising:
a first price conversion unit configured to generate third information by applying a conversion function representing a logarithmic function or an exponential function to the price included in first information associated with the explanatory variables and the price and by associating a second price computed as a result of applying with the explanatory variables associated with the price in the first information;
a component optimization unit configured to optimize the component on the basis on the third information; and
a second price conversion unit configured to predict the price related to the prediction data by applying an inverse function of the conversion function to the price predicted by the price prediction unit.

11. A price prediction method comprising, by an information processing device:
inputting prediction data being one or more explanatory variables potentially influencing a price;
determining a component used for prediction of the price on the basis of:
a hierarchical latent structure in which a latent variable is expressed by a hierarchical structure which includes (i) one or more nodes arranged at each level of the hierarchical structure, (ii) a path between a node arranged at a first level and a node arranged at a subordinate second level, and (iii) the component representing a probability model is arranged in a node at a lowest level of the hierarchical structure,
a gating function model being a basis of determining the path between nodes constituting the hierarchical latent structure, when determining the component, and
the prediction data; and
predicting the price on the basis of the determined component and the prediction data.

12. A non-transitory recording medium recording a price estimation program causing a computer to provide:
a prediction data input function configured to input prediction data being one or more explanatory variables potentially influencing a price;
a component determination function configured to determine a component used for prediction of the price on the basis of:
a hierarchical latent structure in which a latent variable is expressed by a hierarchical structure which includes (i) one or more nodes arranged at each level of the hierarchical structure, (ii) a path between a node arranged at a first level and a node arranged at a subordinate second level, and (iii) the component representing a probability model is arranged in a node at a lowest level of the hierarchical structure,
a gating function model being a basis of determining the path between nodes constituting the hierarchical latent structure, when determining the component, and
the prediction data; and
a price prediction function configured to predict the price on the basis of the determined component and the prediction data.
